(19) United States
(12) Patent Application Publication
(10) Pub. No.: US 2011/0272088 A1
(43) Pub. Date: Nov. 10, 2011

(54) SYSTEMS AND RELATED METHODS FOR TRACTIONAL GRIP FRAMES FOR TABLET DEVICES

(76) Inventor: K. Dominic Cincotti, Wilmington, NC (US)

(21) Appl. No.: 13/102,832

(22) Filed: May 6, 2011

Related U.S. Application Data
(63) Continuation-in-part of application No. 12/950,634, filed on Nov. 19, 2010.
(60) Provisional application No. 61/343,978, filed on May 6, 2010.

(51) Int. Cl. B32B 38/10; B32B 37/12

(52) U.S. Cl. 156/247; 156/60; 156/539; 156/538

(57) ABSTRACT

Grip frame systems and related methods are provided for tablet devices. The grip frame system can create gripping surfaces on a tablet device. The grip frame system can include one or more traction-creating coverings positionable on a portion of at least one of a border surrounding a screen of the tablet device, sides of the tablet device, or a rear face of the tablet device. The traction-creating coverings can include one or more micro-terrain layers forming an outer surface at selected locations that form a frictional contact surface.

### CROSS-REFENCEE TO RELATED APPLICATIONS

This application claims the benefit of U.S. Provisional Patent Application Ser. Nos. 61/343,978, filed May 6, 2010, with the entire contents being hereby incorporated by reference herein. Further, this application is a continuation-in-part patent application which claims the benefit of and priority to the filing date of U.S. patent application Ser. No. 12/950,634, filed Nov. 19, 2010, the disclosure of which is also incorporated herein by reference in its entirety.

### TECHNICAL FIELD

The present disclosure relates generally to mobile tablet devices such as mobile touchscreens, multi-touchscreens, e-readers, and other tablet interface devices. More particularly, the present disclosure relates to traction-creating grip frame systems that can be used on such tablet devices to enhance the handheld traction on the grasping surfaces of the tablet devices during operation and/or transport.

### BACKGROUND

Mobile touchscreen, multi-touchscreen, e-reader, and/or, tablet interface devices (hereinafter referred to as “tablet devices”) like the IPAD® from Apple, Inc., WEPAD™ from WePad, GmbH, and the SLATE™ from Hewlett-Packard, Inc., are being used in many professions by both professionals and other individuals for mobile internet, content, communication and digital resources for work, education, and entertainment. Yet, for many professions, these tablet devices may remain impractical, as the slick surface of their constructions can easily result in slipping, dropping or mishandling, during operation as well as transport. For example, using such tablet devices in a construction, law enforcement, first responder, or military environment can be challenging. Due to the slick materials that are used in the outer construction of such devices, especially the touchscreen, the devices can be hard to hold in environments where the action may be fast paced. These issues are exacerbated by the hands' natural surface, and sweat and oils that are produced, and can also accumulate during handling, transport, or operation (especially in warm or humid environments and during prolonged periods of operation or portability). The gripping surface for these tablet devices often leads to unfortunate accidents where handheld traction is a cause, or a contributing cause to the damage or destruction of the device. These slick gripping surfaces are aesthetically pleasing but do not facilitate safe handling because of the lack of a grip that can be accomplished by a user's hand or a gloved hand. This is especially true when using these tablet devices in work environments that are rigorous and where the user is active.

The outer surfaces intended for grasping these handheld tablet devices could prove to be an obstacle that must be resolved, prior to widespread practical adoption, for some individuals and professions.

### SUMMARY

In accordance with the disclosure herein, grip frame systems and related methods for mobile touchscreen, multi-touchscreen, e-reader and/or tablet inter-face handheld devices (hereinafter “tablet devices”) where the devices are grasped with one or two hands during operation and/or transport and methods for making such grip frame systems are provided. In accordance with this disclosure, some grip frame systems can provide aesthetic aspects that can be used in conjunction with broadcast imagery from a screen of the tablet device to provide certain desired effects. It is an object of the presently disclosed subject matter to provide novel grip frame systems and methods for tablet devices that can enhance the handling of the tablet devices and can enhance certain aesthetic aspects of the tablet devices to meet a user's desires and needs.

An object of the presently disclosed subject matter having been stated hereinabove, and which is achieved in whole or in part by the subject matter disclosed herein, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1 illustrates a perspective view of an embodiment of a tablet device on which an embodiment of a grip frame system is to be applied according to the subject matter disclosed herein;

FIGS. 2 and 3 illustrate perspective views of an embodiment of a tablet device on which an embodiment of a grip frame system according to the subject matter disclosed herein is applied;

FIG. 4 illustrates a perspective view of an embodiment of a table device on which another embodiment of a grip frame system according to the subject matter disclosed herein is applied;

FIGS. 5A and 5B illustrate perspective views of an embodiment of a tablet device on which a further embodiment of a grip frame system according to the subject matter disclosed herein is applied;

FIGS. 6A and 6B illustrate a perspective view of an embodiment of a tablet device from which an embodiment of a grip frame system according to the subject matter disclosed herein is being removed;

FIG. 7 illustrates a step in a process for removing an embodiment of a grip frame system from a tablet device according to the subject matter disclosed herein;

FIGS. 8A and 8B illustrate schematic views of embodiments of cover material that can be used in grip frame systems according to the subject matter disclosed herein;

FIG. 9 illustrates a top plan view of a magnified portion of an embodiment of a micro-terrain layer of a cover material that can be used in grip frame systems according to the subject matter disclosed herein;

FIGS. 10A-10C illustrate schematic views of embodiments of cover material that can be used in grip frame systems according to the subject matter disclosed herein;

FIGS. 11A-11C illustrate schematic views of further embodiments of cover material that can be used in grip frame systems according to the subject matter disclosed herein;

FIG. 12 illustrates a schematic view of an embodiment of a grip frame system being applied to a tablet device according to the subject matter disclosed herein;

FIG. 13 illustrates a perspective view of another embodiment of a grip frame system applied to a tablet device according to the subject matter disclosed herein;

FIGS. 14A-14D illustrate perspective views of embodiments of grip frame systems applied to a tablet device according to the subject matter disclosed herein;

FIGS. 15A-15D illustrate perspective views of embodiments of grip frame systems applied to a tablet device according to the subject matter disclosed herein;

FIGS. 16A-16D illustrate perspective views of embodiments of grip frame systems applied to a tablet device according to the subject matter disclosed herein;

FIGS. 17A and 17B illustrate perspective views of an embodiment of a grip frame system applied to a tablet device according to the subject matter disclosed herein;

FIG. 18A illustrates a perspective view of an embodiment of an antenna system of a tablet device that can work in conjunction with a grip frame system according to the subject matter disclosed herein;

FIG. 18B illustrates a perspective view of an embodiment of grip frame system applied to a tablet device according to the subject matter disclosed herein;

FIGS. 18C and 18D illustrate schematic views of embodiments of cover material that can be used in grip frame systems according to the subject matter disclosed herein; and

FIG. 19 illustrates an embodiment of a kit containing components used to camouflage physical items, such as weapons and accessories according to the subject matter disclosed herein.

### DETAILED DESCRIPTION

Reference will now be made in detail to the description of the subject matter disclosed herein, one or more examples of which are shown in the figures. Each example is provided to explain the subject matter and not as a limitation. In fact, features illustrated or described as part of one embodiment can be used in another embodiment to yield still a further embodiment. It is intended that the subject matter disclosed herein cover such modifications and variations.

“Site-specific” as used herein means a specific local terrain, nautical position, or airspace where a physical item will be located or operating, or the environmental characteristics which would be found in the intended operating environment of the physical item.

“Pattern” as used herein means any color and/or imagery, including, but not limited to camouflage patterns, repeating and non-repeating designs, deceptive designs, such as imagery that give the perception that an item, such a tablet device, has a different appearance and/or outward physical characteristics that can be displayed on a screen of a tablet device and/or printed to a cover material.

“Disruptive pattern” as used herein means a pattern of shapes that when configured on an image will cause visual confusion.

“Distortions,” “distorting,” and variations thereof as used herein means the changing of at least a portion of an image by manipulating the focal lengths within those portions of the image, adding to a first image a portion of the image or a portion of different image that has a different focal length than the first image, or adding shapes or color that change the appearance of the image. Focal lengths can include improper focal lengths that cause at least a portion of the image to appear to be out of focus.

“Focal lengths” as used herein means the distance at which an image will come into visual focus either by a human observer or through electronic, electromechanical and/or optical methods and devices. Focal lengths can include improper focal lengths that cause at least a portion of the image to appear to be out of focus.

“Image-editing program” as used herein means a computer program used to edit or change an image. Examples include Adobe PHOTOSHOP®, PAINT.NET® and PICASA®.

“Image” as used herein means the optical counterpart of an object or environment produced by graphical drawing by a person, a device (such as a computer) or a combination thereof. The optical counterpart of the object can also be produced by an optical device, electromechanical device, or electronic device. As used herein, “image” can be used to refer to a whole image, for example, a photographic image as taken by a photographic device, or a portion thereof.

“Physical item” as used herein can include, but is not limited to, any and all types of vehicles (land, air and sea, and rail/manned & unmanned), aircraft, watercraft, structures, buildings, pipes and piping, equipment, weapons, hardware, computer, tablet device and other items used for personal, commercial, military or other purposes.

“Nanomaterial” as used herein means nano-scale technology, such as nanoparticles or clusters of nanoparticles. Nanoparticles can behave as a whole unit in terms of its transport and properties. Nanomaterial can include but is not limited to aerogel in powder form, clusters of powdered aerogel, microspheres and clusters of microspheres.

“Tablet device” as used herein means an electronic device that can be used for information processing and/or communications that can be held in one or two hands of a user during operation and transport. “Tablet device” as used herein can include, but is not limited to, hand-held computing devices, such as mobile touchscreen, multi-touchscreen, e-reader, and/or, tablet interface devices, for example, as an IPHONE® or an IPAD® from Apple, Inc., a XOOM®, a Droid™ from Motorola, Inc., a KINDLE® from Amazon Digital Services, Inc., a WEPAD™ from WePad, GmbH, a SLATE™ from Hewlett-Packard, Inc., or the like.

“Cover material” as used herein means a materials used for placement over or on a surface, such as an exterior surface, of a physical item to provide protection of the physical item. “Cover material” as used herein can include, but is not limited to, spraying coatings, extruded coatings, films, thin film, such as nanomaterial based coatings and silica particle coatings, laminates, optically clear laminates, or the like.

“Traction-creating covering” as used herein means a cover material that that has one or more portions or areas having a frictional contact surface. “Traction-creating covering” as used herein can include, but is not limited to, spraying coatings, extruded coatings, films, thin film, such as nanomaterial based coatings and silica particle coatings, laminates, optically clear laminates, or the like.

“Grip frame system” as used herein means a system that can be placed on a device, such as a tablet device, to provide a frictional contact surface to increase the ability of a user to firmly hold the device. “Grip frame system” as used herein can include, but is not limited to, a system of cover material that can be placed on a device, such as a tablet device, to provide a frictional contact surface.

Tablet-style handheld touchscreen mobile devices have an increased need for handheld traction on the gripping surfaces of the device. The slippery outer surfaces of these tablet devices, such as mobile touchscreen, multi-touchscreen, e-reader, and/or tablet interface devices like an IPAD®, a WEPAD™, and a SLATE™, are impractical for some individuals and their work environments. So, an improved gripping or handling surface for these tablet devices would be welcomed and could lead the way toward a more widespread adoption of the devices by a wider range of professions and users. An improved gripping or handling surface for these tablet devices could lead to fewer unfortunate accidents where handheld traction is a cause, or a contributing cause to the damage or destruction of the device.

To improve the grip or handling surface for these tablet devices, lightweight friction-creating or traction-creating coatings, films or coverings can be placed in the areas associated with hand placement on slick surfaces of both the top and bottom of these tablet devices. A lightweight traction-creating grip frame system can enhance the handheld traction on the grasping surfaces of the tablet devices, during operation or transport. A traction-creating grip frame system can fulfill the need for a more sure-handed grip, as well as other needs.

The traction-creating grip frame system for such tablet devices can be lightweight and can be wrapped, coated, adhered, or securely affixed over, around, or on top of one or more areas of the exterior of the devices. In particular, the traction-creating grip frame system can be applied to the area or areas that correspond to the bezel or border areas of the tablet device.

The traction-creating grip frame system can be applied to the outermost surface layer-areas associated with common hand, finger, or opposable thumb positions on the device during operation or transport. The grip frame system can be referred to as such, because it covers the device's exterior surface area, or areas with, a frictional surface while leaving the devices' front touchscreen display either uncovered or optically clear.

The traction-creating grip frame system can be positioned and applied in such a way, so as not to interfere with the touchscreen or multi-touchscreen operation. Also, the traction-creating grip frame system can still allow the passage, broadcast, and/or reception of necessary signals required by the device. Further, as the bezels themselves become touch control activated features on these tablet devices (as in the case of intelligent-bezels), a traction-creating grip frame system can provide both frictional grip and permit operation of the touch-controlled, or intelligent, bezel by transferring or allowing touch capacitive input though a touchscreen grip or wrap material.

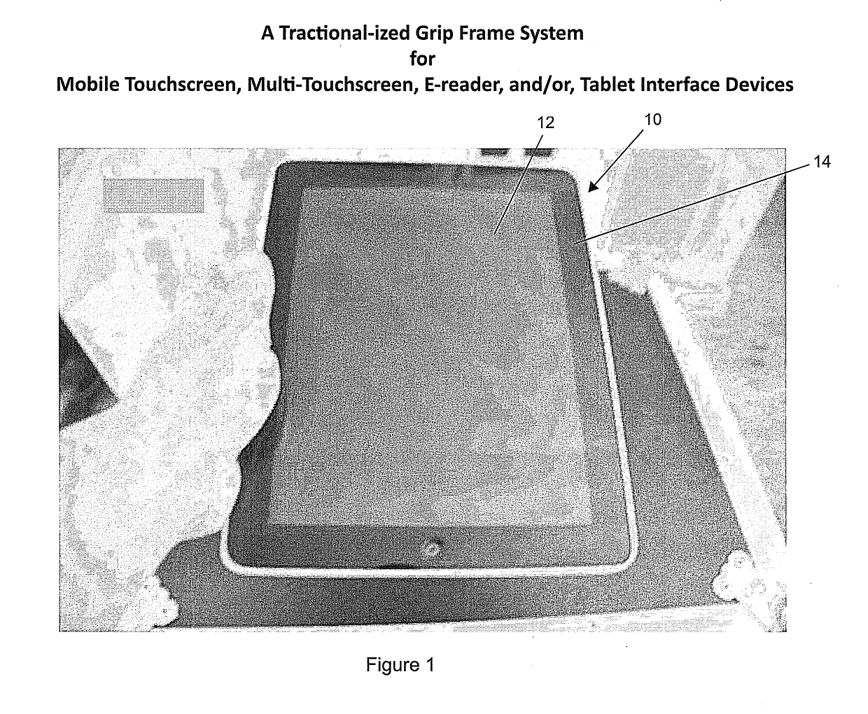

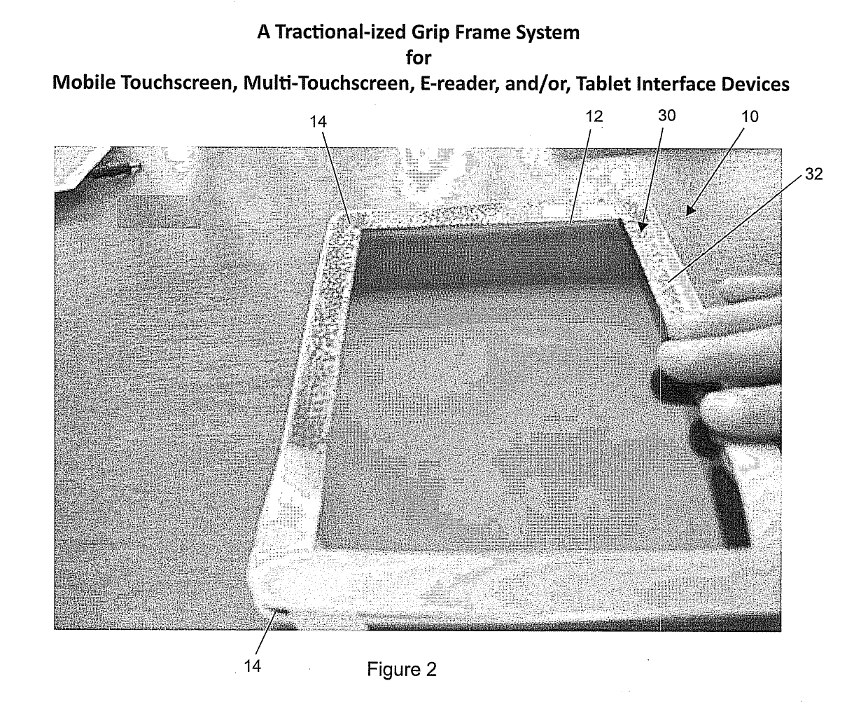

FIG. 1 illustrates a tablet device generally designated 10 that can be grasped with one or two hands during operation or transport. Tablet device 10 can have a front face that has a screen 12 and a border, or outer-edge section, 14 on the front face where a thumb, finger, or hand of a user would normally contact tablet device 10 during transport or operation. As shown in FIG. 2, tablet device 10 can have a grip frame system generally designated 30 that comprises cover material, such as one or more traction-creating coverings 32, placed around border 14 of tablet device 10 that surrounds screen 12 where the thumb, finger or hand of a user would normally contact tablet device 10 during transport or operation for the purpose of enhanced handheld traction.

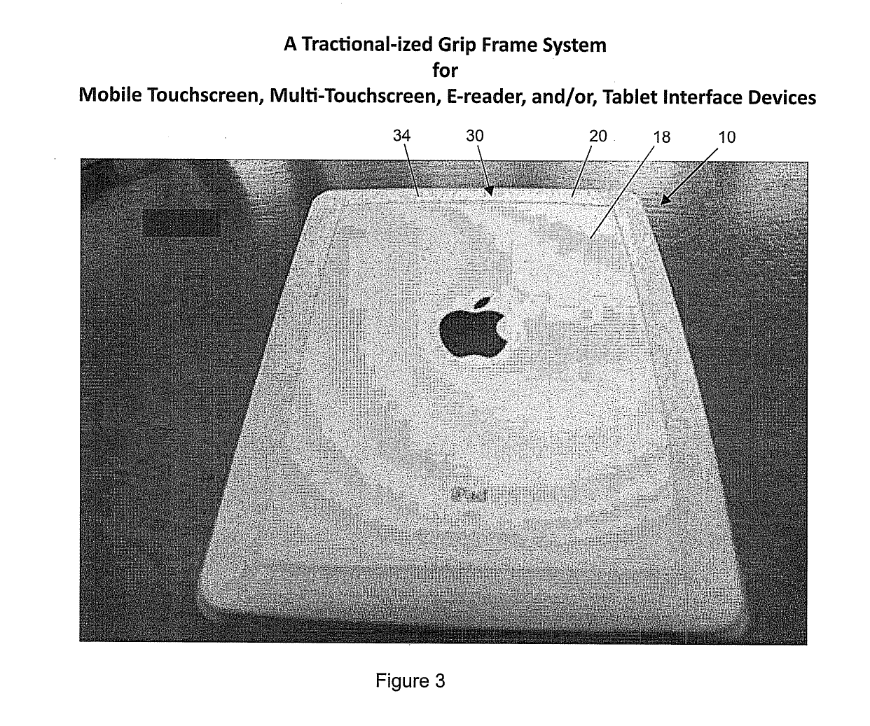

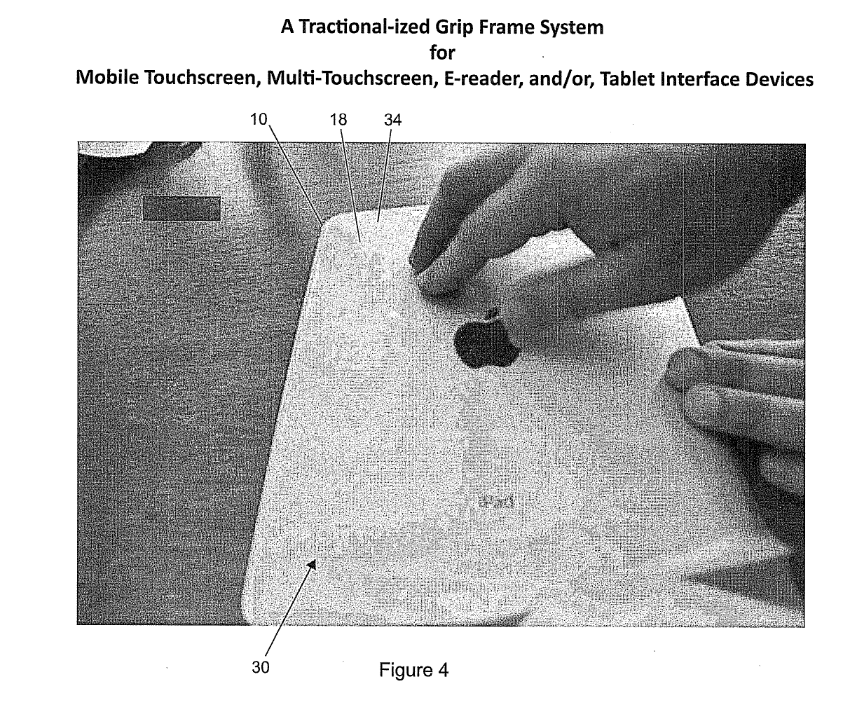

Tablet device 10 can also include a rear face 18 as shown in FIG. 3. Rear face 18 can comprise an outer edge 20 that encompasses or at least partially surrounds the rest of rear face 18. As shown in FIG. 3, grip frame system 30 can also comprise a cover material, such as one or more traction-creating coverings 34 that can be attached to outer edge 20 of rear face 18 of tablet device 10. Alternatively, as shown in FIG. 4, grip frame system 30 can comprise traction-creating coverings 34 can be used to cover the entire, or a majority of, rear face 18 of tablet device 10.

Traction-creating coverings 32, 34 of grip frame system 30 that are used to wrap, cover or coat the areas of tablet device 10 associated with handheld gripping or holding during use or transport can be a film, laminate, or other coating. Traction-creating coverings 32, 34 can be, for example, a lightweight traction enhancing frictional micro-terrain laminate, or coating, which is described in more detail below.

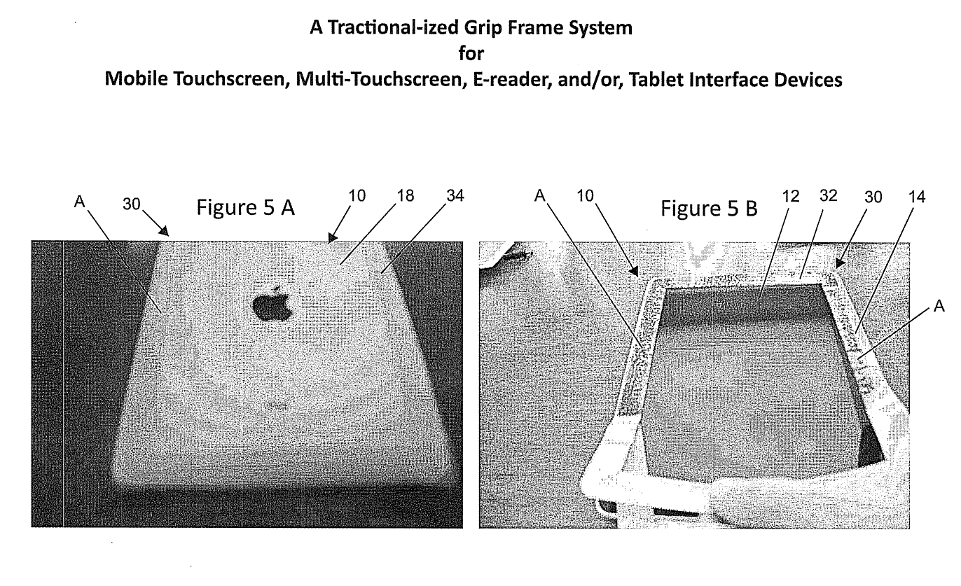

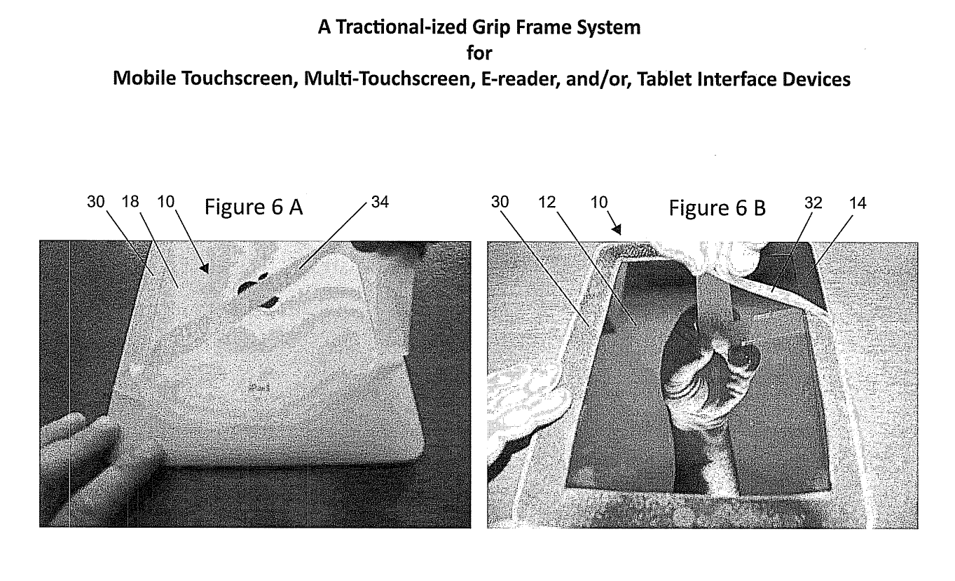

Traction-creating coverings 32, 34 that can be used in grip frame system 30 for tablet devices, such as tablet device 10, can comprise a frictional transparent or semi-transparent coating, or layer that features an adhesive on a back side of the coating or layer. The adhesive permits traction-creating coverings 32, 34 to be applied to tablet device 10 to cover selected areas, or all the areas of the devices surface exterior, except, for example, input or output sections (such as USB ports, charging ports, speaker ports, microphone ports, camera ports, etc.), and the areas associated with input, rather than contact. For example, traction-creating coverings 32, 34 of grip frame system 30 can be an adhesive, friction-creating micro-terrain film, laminate, or coating, which can be applied to border surface 14 and/or portions of rear face 18 of tablet device 10 for the purpose of providing traction or grip on the slick surface of touchscreen 12 and border 14 and rear face 18. Grip frame system 30 can be adhered in the non-touch-enabled outermost border portions and the back and sides of tablet device 10, or the areas where thumbs, fingers or hands of a user would come in contact during normal operation, handling or transport, for example, in the areas shown in FIGS. 5A and 5B. As shown in FIGS. 6A and 6B, traction-creating coverings 32, 34 of grip frame system 30 can be removable from tablet device 10.

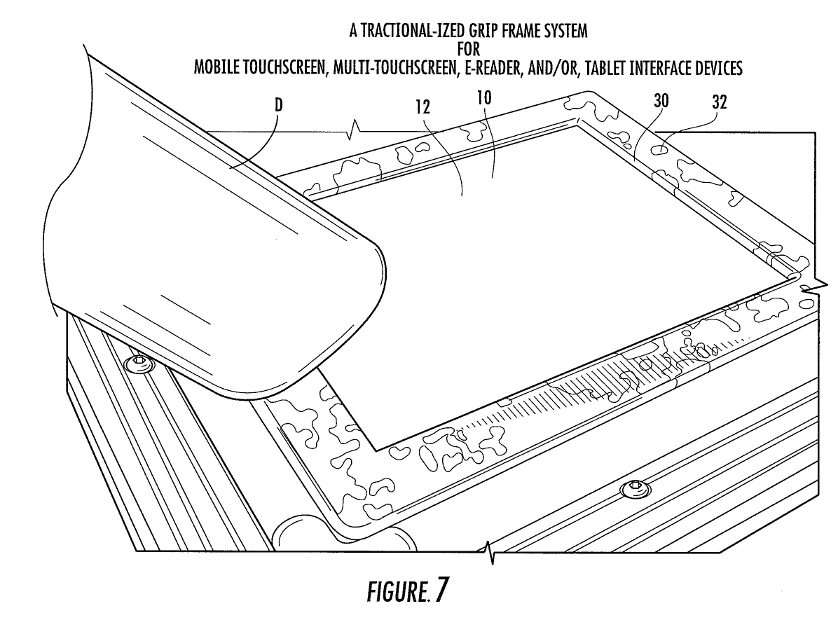

Traction-creating coverings 32, 34 that can comprise the traction-creating grip frame system 30 for tablet devices 10 can be a frictional transparent or semi-transparent coating that can include a heat sensitive adhesive layer. In some embodiments, frictional transparent or semi-transparent coating with a heat sensitive layer can also cover all the areas of the devices surface exterior, except input or output sections, and the areas associated with input, rather than contact. As shown in FIG. 7, such traction-creating coverings 32 of grip frame system 30 can be removable by applying heat, for example, through a heat creating device, such as a heat gun or dryer D, to the surface of traction-creating covering 32 prior to removal. The heat can loosen the adhesive layer for easy removal of traction-creating covering 32 from around screen 12 of tablet device 10.

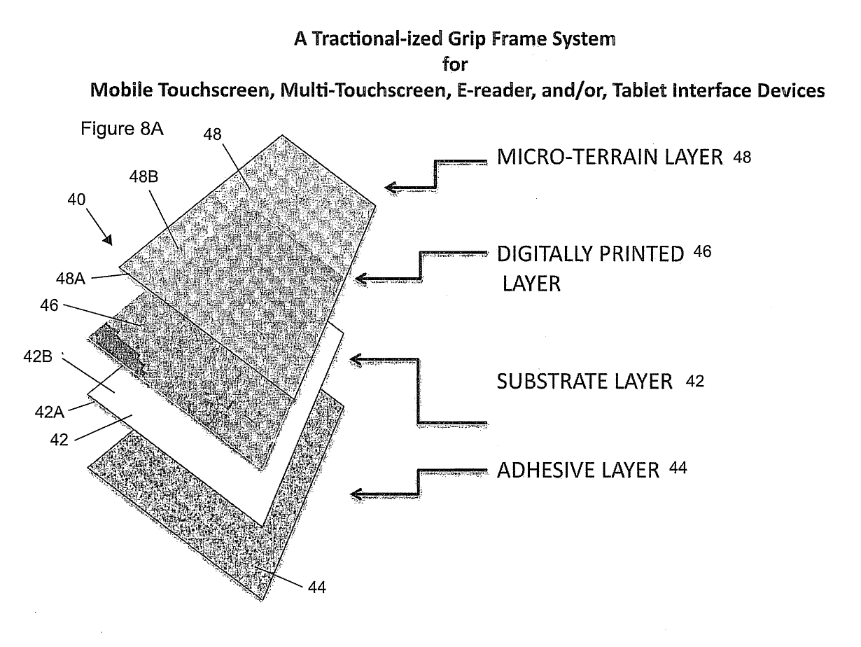

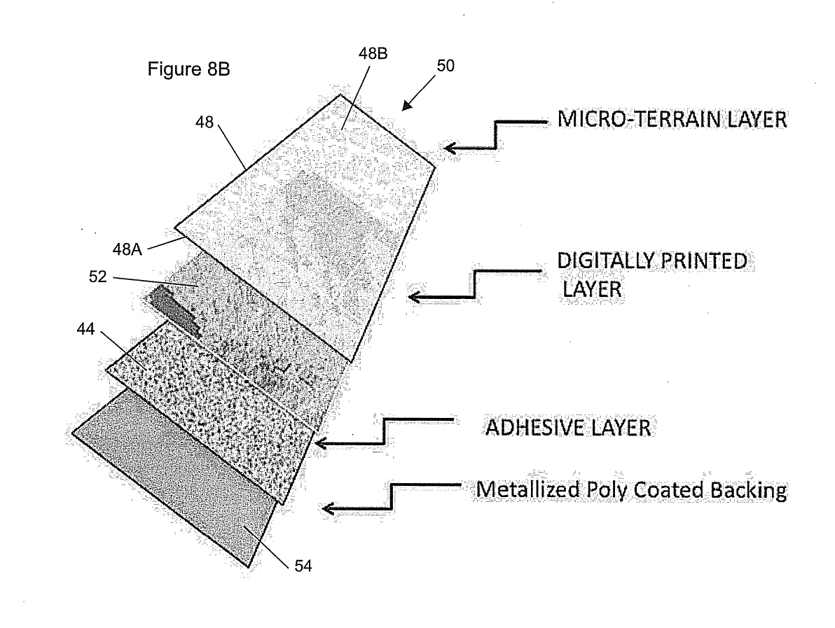

As shown in FIG. 8A, the traction-creating coverings that can be used in a grip frame system for tablet devices can comprise a cover material generally designated 40, which can be, for example, an adhesive strata-structured material. Cover material 40 can comprise a substrate layer 42 that can have an adhesive layer 44 on a back side 42A of the substrate layer 42. A printed layer 46, which can be a digitally printed layer, can be disposed on a front side 42B of substrate layer 42. Printed layer 46 can comprise ink printed on front side 42B of substrate layer 42. In some embodiments, a micro-terrain layer 48 can be disposed on printed layer 46 and/or substrate layer 42 and can serve as the outer layer of the traction-creating covering created by cover material 40 to provide a frictional contact surface.

Printed layer 46 can be a camouflage pattern or images that can include distortions, disruptive patterns, or improper focal lengths. Additionally or alternatively, printed layer 46 can be any image or images that the user of the tablet device 10 needs or desires. For example, printed layer 46 can provide aesthetic images that can personalize tablet device 10. Alternatively, as shown, printed layer 46 can provide images useful for tactical, strategic or work-related purposes. An overlaminate barrier layer (not shown) that can be, for example, a film layer, can be positioned between printed layer 46 and micro-terrain layer 48. Such an overlaminate barrier layer can protect printed layer 46 so that micro-terrain layer 48 can be selectively placed on cover material 40. Such an overlaminate barrier layer can be transparent or semi-transparent. In some embodiments, micro-terrain layer 48 can be a protection layer.

For example, cover material 40 can be a multi-layered adhesive camouflage material featuring a micro-terrain layer 48 that is transparent or semi-transparent in the outer-most physical strata for increased friction with another contacting surface for improved performance, functionality or operation. Micro-terrain layer 48 can be selectively placed on the surface of printed layer 46 and substrate layer 42 so that the grip portions of traction-creating coverings 32, 34 are only in positions where they are needed. This material can have an underlying printed visual camouflage design layer 46 that can be printed on front side substrate layer 42 that allows for the completion or continuation of the same visual camouflage pattern between areas of frictional need and those areas without this need. For example, printed layer 46 can be a camouflage image that provides visual cover for a tablet device when the device is used in a situational environment where the tablet device and the user should blend therein. Substrate layer 42 can be a polymer-based film material with adhesive layer 44 on its back side 42A that can be applied to a surface of a tablet device. Alternatively adhesive layer can be applied to the tablet device or back side 42A of substrate layer 42 when the grip frame system is being applied to the tablet device. Substrate layer 42 can be, for example, a vinyl film, such as polyvinyl chloride or polyvinyl alcohol. In some embodiments, substrate layer 42 can comprise polytetrafluoroehtylene (PTFE).

Thus, cover material 40 can be a conformable and adhere-able polymer based strata-structure that allows the same camouflage imagery to be continued or incorporated into both frictional-need areas and non-frictional-need portions of the cover material, or more specifically the traction-creating coverings used on the tablet devices thereby providing more effective camouflage by providing more continuous or total areas of coverage. The underlying adhesive, substrate, and digital printed layers can comprise the same such layers shown and described in detail in U.S. patent application Ser. No. 12/221,540 for CAMOUFLAGE PATTERNS, ARRANGEMENTS AND METHODS FOR MAKING THE SAME and U.S. patent application Ser. No. 12/386,986 for VISUAL CAMOUFLAGE WITH THERMAL AND RADAR SUPPRESSION AND METHODS FOR MAKING THE SAME; the entireties of both these applications are incorporated herein by reference. Further, the transparent or semi-transparent micro-terrain layer or strata and the application of this and the other layers can be similar to the materials and the layer applications described in detail in U.S. patent application Ser. No. 12/950,634 for CAMOUFLAGE SYSTEMS, KITS AND RELATED METHODS WITH FRICTIONAL CONTACT SURFACES, the entirety of which is also incorporated herein by reference.

Still referring for example to FIG. 8A, micro-terrain layer 48 can include microstructures that roughen the surface of the layer to create a frictional contact surface. The microstructures, for example, can create ridges and valleys on its outer surface to create a frictional contact surface. The outer surface of micro-terrain layer 48 can be a soft pliable surface to increase the effectiveness of the ridges and valleys of the microstructures. Micro-terrain layer 48 can be simultaneously coordinated with, and/or can be used to complete, the greater visual camouflage design pattern of the underlying design. The microstructures of micro-terrain layer 48 can be filled with or can house and protect transparent or semi-transparent multi-spectral signature suppression materials therein.

For example, thermal and radar signature suppression counter-measures can be embedded into micro-terrain layer 48 and/or in or between other layers of frictional adhesive cover material 40 such as substrate layer 42, adhesive layer 44, adhesive layer 44, and printed layer 46. The thermal and radar signature suppression counter-measures can be nanomaterial such as nanoparticles or clusters of nanoparticles. For example, thermal and radar signature suppression counter-measures can be nano-scale, air or gas -filled microspheres or micro-balloons that can also be metallic coated, such as cenospheres, and pulverized aerogels that consist of over 90% air in nano-scale pores that inhibit heat transfer with low density. These materials in combination with one another can provide the mechanism for simultaneous visual camouflage and thermal and radar signature suppression. Such nanomaterials that can be used in cover material 40 are discussed further below.

The nanomaterials used in cover material 40 can include aerogels and microspheres. Aerogels that can be used in cover material 40 can be solid-state materials with very low densities. Aerogels describe a class of material based upon their structure, namely low density, open cell structures, large surface areas (often 900 m²/g or higher) and sub-nanometer scale pore sizes.

Supercritical and subcritical fluid extraction technologies are commonly used to extract the fluid from the fragile cells of the material. A variety of different aerogel compositions are known and may be inorganic or organic. Inorganic aerogels are generally based upon metal alkoxides and can include but are not limited to materials such as silica, carbides, and alumina. Organic aerogels include carbon aerogels and polymeric aerogels such as polyimides.

Aerogels can be derived from a gel in which the liquid component of the gel has been replaced with gas. The result is an extremely low-density solid with several remarkable properties, most notably its effectiveness as a thermal insulator. Aerogels are good thermal insulators. As stated above, the aerogels can include silicon, carbon and metallic aerogels, such as alumina aerogels. Silica aerogels can be a good conductive insulator because silica is a poor conductor of heat. A metallic aerogel, on the other hand, may be a less effective insulator. Carbon aerogel is a good radiative insulator because carbon absorbs the infrared radiation that transfers heat at standard temperatures. Another good insulative aerogel is silica aerogel with carbon added to it.

When incorporated into cover material 40 described herein and cover material 40 is secured around a tablet device, such insulative aerogels can provide good suppression of the thermal signature of the physical item. The aerogels can be pulverized into a powder form and embedded into a vinyl layer during manufacturing of the layer. The aerogels can contain particles ranging in size between about 1 to 10 nm, for instance about 2 to about 5 nm, that are generally fused into clusters. Alternatively, the aerogels can be included in the adhesives, inks, or laminate layer used on the vinyl layer. The inclusion of the aerogels, even in their pulverized or powder form, in cover material 40 can facilitate thermal suppression in the system and may improve radar suppression as well.

Similarly, microspheres can be included in cover material 40. Microspheres are hollow microsphere particles that can be made from metal (e.g., gold), metal oxides (e.g., Al₂O₃, TiO₂, ZrO₂), silica, or the like. Microspheres can be fabricated with various diameters and wall thicknesses.

The microspheres can include glass microspheres and cenospheres. Hollow glass microspheres, sometimes termed microballoons, have diameters ranging from about 10 to about 300 micrometers. A cenosphere is a lightweight, inert, hollow sphere filled with inert air or gas, typically produced as a byproduct of coal combustion at thermal power plants. The color of cenospheres varies from gray to almost white and their density is about 0.4-0.8 g/cm³, which gives them great buoyancy. Cenospheres are hard and rigid, light, waterproof, innoxious, and insulative.

When incorporated into cover material 40 described herein and cover material 40 is secured around a tablet device, microspheres such as those described above, including glass, ceramics, and/or alumina silicate, can provide good suppression of the radar signature of the physical item. These microspheres can be embedded into the vinyl layer during manufacturing of the layer. Alternatively, the microspheres can be included in the adhesives, inks, or over-laminate used on the vinyl layer. The microspheres can contain particles ranging in size between about 10 to 300 micrometers, for example about 10 to about 20 micrometers. The microspheres can be generally fused into clusters. The microspheres separately and in clusters reflect waves in irregular or dispersed fashion to make a wave signature hard to detect. Thus, the inclusion of the microspheres in cover material 40 facilitates radar suppression and may improve thermal suppression.

In some embodiments, the placement and selection of micro-terrain layer 48 can be utilized to increase handheld traction. Selection of micro-terrain layer 48 relates to the type and sizes of microstructures used in the micro-terrain layer 48. Different sizes and shapes of the microstructures and the material used to make them can affect the frictional traction that they can create. For example, the micro-terrain of micro-terrain layer 48 can improve traction by diverting and removing sweat and oils within the micro-terrain to maintain tractional grip. For instance, by increasing the differences in elevational distances in the difference physical structures of the micro-terrain, further improvements for handheld traction can be achieved. The differences in the elevational distances create different sized cavities with regard to the ridges and valleys of the micro-terrain, for the accumulation of sweat and oils as explained further below. In this way, advanced handheld traction can be achieved.

In some embodiments, the traction-creating coverings used as a cover material in a grip frame system can include selectively placed micro-terrain layers 48 over certain areas of a cover material such a cover material 40 having a substrate layer 42, printed layer 46, and adhesive layer 44 as described above. In some embodiments, different micro-terrain layers 48 can be applied at different locations of such a cover material. For example, different micro-terrain layers 48 having different microstructures can be applied at different locations on the cover material to provide different grip capabilities at those locations as explained further below. Also, micro-terrain layer 48 can be overlaid on other micro-terrain layer 48 or on other cover material. For example, micro-terrain layer 48 can be placed on top of hydrophobic coatings in areas on the tablet device associated with heavy handheld use. Micro-terrain layer 48 can be placed on top of cover material such as wrap material like PHOTO STEALTH® or PHOT REAL® manufactured and sold by MW Defense Systems, Inc. located in Lumberton, North Carolina. In these manners, advanced traction in handheld heavy-use areas can be achieved by placement of micro-terrain layer 48 within a grip frame system.

A micro-terrain layer 48 can serve as a traction-creating covering 32 without a separate substrate layer. A micro-terrain layer 48 can have an adhesive layer applied to a back face and it can then be applied directly to a tablet device. Alternatively, a micro-terrain layer 48 can have an image printed on it before application to a tablet device. As shown in FIG. 8B, a cover material 50 can comprise a micro-terrain layer 48 that can have a front face 48B that serves as the outer physical surface that includes the microstructures that enhance the frictional contact surface and a back face 48A on which an image can be printed. A digital image can be reverse printed on back face 48A so that is shows through front face 48B to create a reverse digitally printed layer 52. After the printed image is reverse printed onto back face 48A of micro-terrain layer 48, an adhesive layer 44 can be applied on top of printed layer 52. At this point, micro-terrain layer 48 can be applied to a tablet device. Thus, micro-terrain layer 48 can be a reverse printable laminate featuring a micro-terrain in the outermost surface with an underside of which is reverse printable.

As shown in FIG. 8B, cover material 50 can include a pre-application metalized poly-coated backing 54 that can be removed before cover material 50 is applied to create traction coverings for a grip frame system. Cover material 50 can be prepared for application through heat activation of the adhesive on adhesive layer 44 via metalized poly-coated backing 54. Adhesive layer 44 can be disposed on micro-terrain layer 48 on one side of adhesive layer 44 and metallic poly-coated backing 54 can disposed on an opposite side of adhesive layer 44. This backing 54 can be heated prior to removal and application of cover material 50 onto a tablet device. Metalized backing 54 can spread heat more readily. It can also improve the adhesive activation and can allow cover material 50 of the grip frame system to be heated separately. Metalized poly-coated backing 54 can be a removable layer that includes a metal thin-film or metalized thin film sandwiched between layers of coatings with non-stick properties. Cover material 54 can be heated from the underside. Removable metalized poly-coated backing 54 can transfers the heat more efficiently thus beginning the activation process of the adhesive in adhesive layer 44. Backing 54 can be removed next, and cover material 50 can be applied to a touch screen of a tablet device. Such backings 54 can be used on other embodiments of cover materials, like cover material 40. Using such backing 54 can also limit the effect that the heating process has on the cover materials including the micro-terrain of micro-terrain layer 48 and possibly printed layer 46. Increased curing time can be doubled for the adhesive to securely bond to an oleophobic-coated touch screen of a tablet device.

Referring back to FIG. 8A, frictional adhesive cover material 40 with micro-terrain layer 48 either selectively positioned on cover material 40 or entirely forming the outer most layer of cover material 40 can be applied to borders 14 of touchscreen 12 as traction-creating coverings 32, 34 to create a grip frame system 30 (see FIGS. 1-7) that does not interfere with operation of the touch capacitive surface on the interior portion of the frame of the tablet device 10. Such frictional adhesive cover material 40 does not have to interfere with the functioning of the underlying surface to which it is applied, or from which it is subsequently removed.

In other embodiments, the grip frame system and its cover material, such as cover materials 40, 50 can be used for coverage over an oleophobic coating or oleophobic-coated touch screen. Situated and applied at the border or gripping edge of the device, micro-terrain layer 48 can feature oleophobic, hydrophobic, or oleophobic-hydrophobic coatings, itself. These coatings can be deposited in an organic solvent subtraction method at the upper elevations of outermost surface of micro-terrain layer 48. An organic solvent subtraction method is a process of adding an organic solvent for later extraction, usually through evaporation. In this manner, coverage of a tablet device, improved grip, and oleophobic/hydrophobic or oleo-hydrophobic properties can be combined.

In some embodiments, a cover material of a grip frame system can be a self-adhesive, singular pre-cut PTFE that features an optically clear inner area, which continues or extends into an outer area. The inner area can correspond to the touch activated or touch capacitive portions or elements on the tablet device, such the touch screen and/or intelligent, or touch capacitive, bezels. The outer area can correspond to the border and gripping areas of the tablet device. The inner area does not feature a micro-terrain layer. However, the outer area can be tractionally enhanced with the micro-terrain layer. This micro-terrain layer can be formed by either depositing on the PTFE film or embossing the PTFE film. In such embodiments, the grip frame system can be adhered to oleophobic-coated touch screens.

In further embodiments, cover material 40 of the grip frame system can be a self-adhesive PTFE that can be adhered to touch screen surfaces that may already be coated with oleophobic, hydrophobic, or oleo-hydrophobic coatings. Cover material 40 of the grip frame system, such as traction-creating coverings can be optically clear in the inner frame area of the touch screen surface extending to the border or gripping edges, which features a translucent micro-terrain layer 48.

Adhesive layer 44 can contain micro-balloons of adhesive. Micro-balloons refer to the small spherical structures that can house the adhesive. When activated by heat and pressure, these spherical structures can burst, and application of the adhesive onto a surface can be achieved. The size, number, and placement of these micro-balloons for a grip frame system, including a cover material used for a touch screen covering purposes, affects the adhesion and curing times onto oleophobic coatings. Smaller sized micro-balloons allow for better coverage over the oleophobic coating and also decreases the curing time. By decreasing the size of the micro-balloons that contain the adhesive, which burst through heat and pressure during application, and increasing the number of micro-balloons contained in the adhesive layer, an improved and secure bond can be achieved.

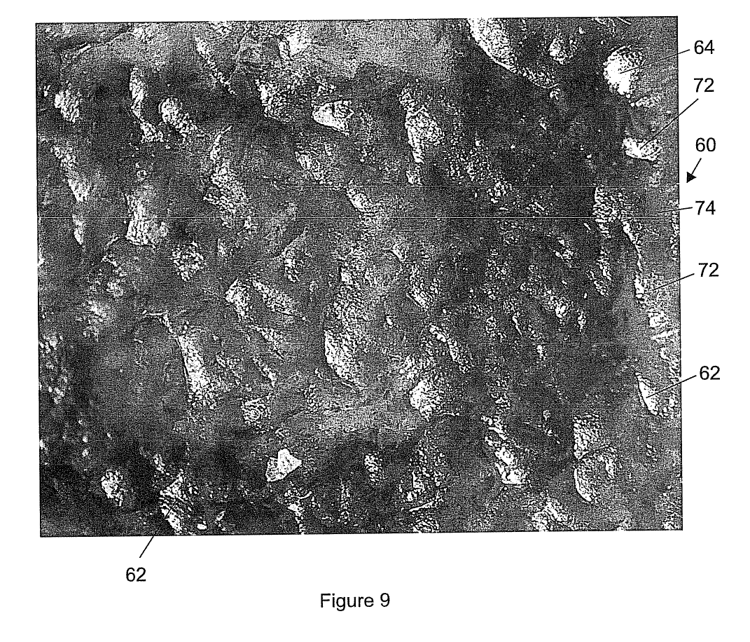

FIG. 9 illustrates a magnified view of a micro-terrain layer generally designated 60. Micro-terrain layer 60 can be transparent or semi-transparent. Alternatively, micro-terrain layer 60 can have an image or camouflage pattern printed on or embedded therein. For example, micro-terrain layer 60 can be simultaneously coordinated with, and/or can be used to complete, a greater visual camouflage design pattern of an underlying design. Micro-terrain layer 60 can include microstructures 70 that roughen the surface of the layer 60 to create a frictional contact surface 62. The microstructures 70, for example, can create ridges 72 and valleys 74 on its outer surface 64 to create frictional contact surface 62. The outer surface 64 of micro-terrain layer 60 can be a soft pliable surface to increase the effectiveness of the ridges 72 and valleys 74 of the microstructures 70. The microstructures 70 of the micro-terrain can be filled with or can house and protect multi-spectral signature suppression materials therein.

In some embodiments, the placement and selection of micro-terrain layer 60 can be utilized to increase handheld and grasping traction. Selection of micro-terrain layer 60 relates to the type and sizes of microstructures 70 used in micro-terrain layer 60. Different sizes and shape of microstructures 70 and the material used to make them can affect the frictional traction that they can create. For example, the micro-terrain of the micro-terrain layer 60 can improve traction by diverting and removing sweat and oils within the micro-terrain, tractional grip can be maintained. For example, by increasing the differences in elevations in the microstructures 70 of the micro-terrain, further improvements for handheld traction can be achieved. The differences in the elevations create the cavities with the valleys 74 between the ridges 72 of the micro-terrain, for the accumulation of sweat and oils. In this way, advanced traction is achieved.

As above, micro-terrain layer 70 can feature oleophobic, hydrophobic, or oleophobic-hydrophobic coatings, itself. These coatings can be deposited in an organic solvent subtraction method at the upper elevations of outermost surface of micro-terrain layer 70. An organic solvent subtraction method is a process of adding an organic solvent for later extraction, usually through evaporation. In this manner, coverage of a tablet device, improved grip, and oleophobic/hydrophobic or oleo-hydrophobic properties can be combined. This micro-terrain layer 70 can also be formed, for example, by either depositing on the PTFE film or embossing the PTFE film. Thus, the micro-terrain layer 70 can include microstructures that roughen the surface of the layer to create a frictional contact surface.

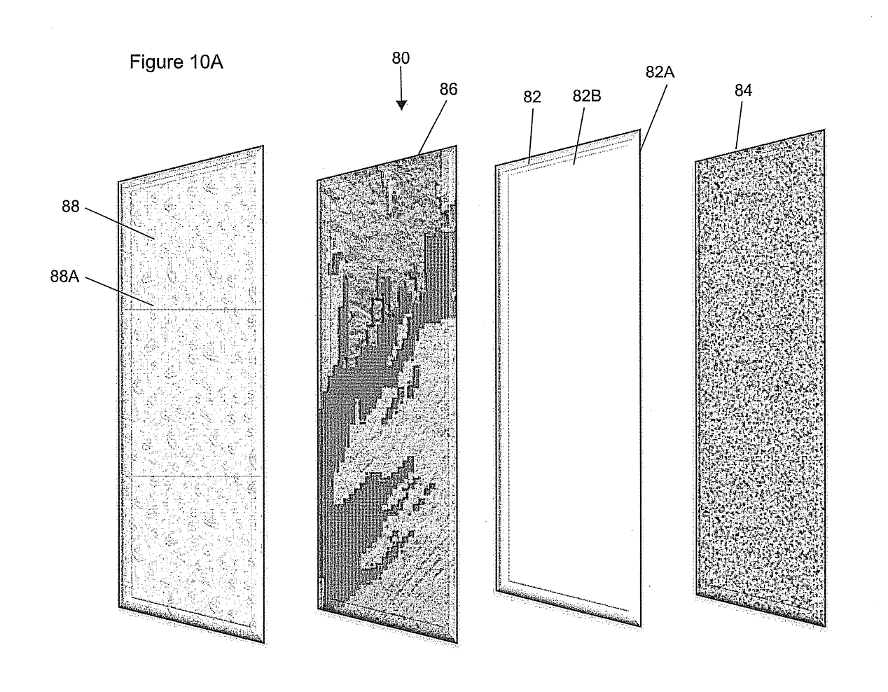

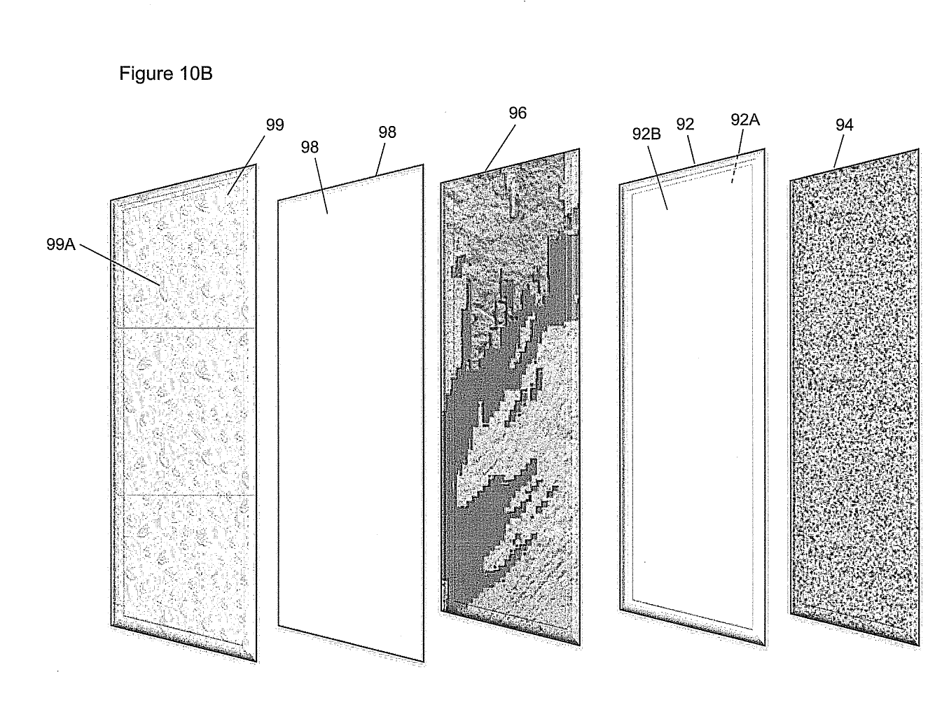

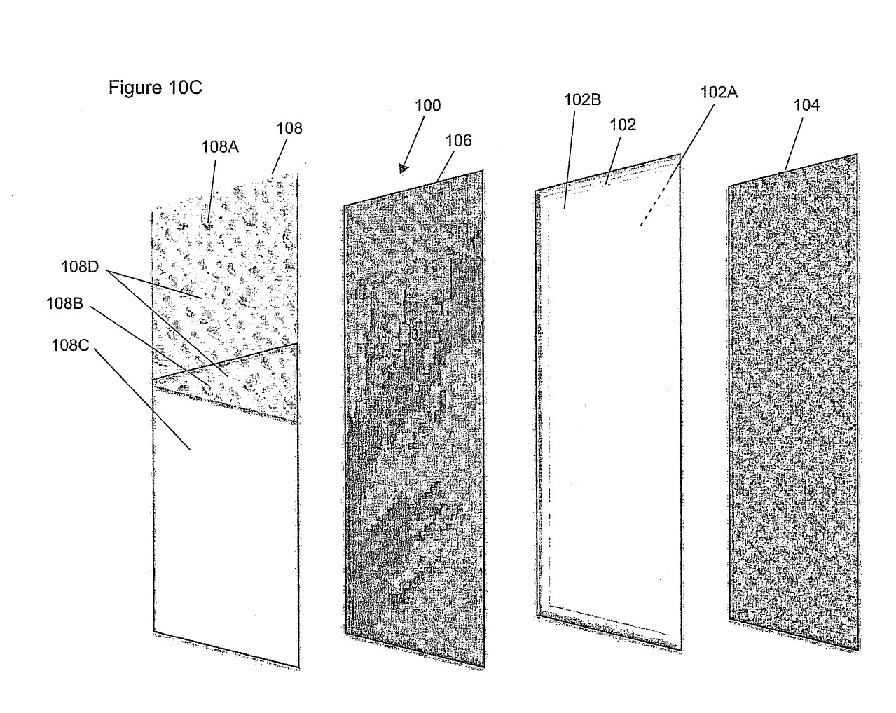

As shown in FIGS. 10A-10C, different embodiments of cover materials that can increase traction are shown. In FIG. 10A, a cover material, generally 80, is provided that has a strata structure of different layers. The cover material 80 can comprise a substrate layer 82 that can have an adhesive layer 84 on a back side, or surface, 82A of the substrate layer 82. A digitally printed layer 86 can be disposed on a front side, or surface, 82B of the substrate layer 82. A micro-terrain layer 88 can be disposed over the digitally printed layer 86 and substrate layer 82 and can serve as the outer layer of the cover material 80 to provide a frictional contact surface 88A. The digitally printed layer 86 can provide images useful for tactical, strategic or work-related purposes. In some embodiments, the different strata or layers 82, 84, 86, and 88 of the cover material 80 can include nanomaterials as described above. Alternatively, in some embodiments, no such nanomaterial may be included in layers 82, 84, 86, and 88 of the cover material 80.

In FIG. 10B, another cover material, generally 90, is provided that has a strata structure of different layers. As above, the cover material 90 can comprise a substrate layer 92 that can have an adhesive layer 94 on a back surface 92A of the substrate layer 92. A digitally printed layer 96 can be disposed on a front surface 92B of the substrate layer 92. A laminate layer 98 can be disposed over the digitally print layer 96 and substrate layer 92. A micro-terrain layer 99 can be disposed over at least a portion of the front surface 98A of laminate layer 98. For example, micro-terrain layer 99 can be placed at selective locations on the laminate layer 98 where traction will be needed. The substrate layer 92, the print layer 96, the laminate layer 98 and as applicable the adhesive layer 94 can constitute a camouflage layer that can be applied to a physical item by itself with the micro-terrain layer 99 being applied later. Thus, the lower layers 92, 94, 96, and 98 can be used to form a camouflage layer without special traction enhancements and micro-terrain layer 99 can the placed at specific locations where traction is likely to be needed after the lower layers 92, 94, 96, and 98 of cover material 90 is secured on a physical item such as a weapon, vehicle, military equipment or hardware. Therefore, the micro-terrain layer 99 can selectively provide a frictional contact surface 99A. The digitally printed layer 96 can provide images useful for tactical, strategic or work-related purposes. In some embodiments, as above, the different strata or layers 92, 94, 96, 98, and 99 of the cover material 90 can include nanomaterials as described above. Alternatively, in some embodiments, nanomaterial can be excluded in layers 92, 94, 96, 98, and 99 of the cover material 90.

In FIG. 10C, a different embodiment of cover material, generally 100, is provided that has a strata structure of different layers. As above, the cover material 100 can comprise a substrate layer 102 that can have an adhesive layer 104 on a back surface 102A of the substrate layer 102. A digitally printed layer 106 can be disposed on a front surface 102B of the substrate layer 102. A top layer 108 can be disposed over the digitally printed layer 106 and substrate layer 102. Top layer 108 can comprise one or more micro-terrain layer portions 108A, 108B and a traditional smooth laminate layer portion 108C. For example, micro-terrain layer portions 108A, 108B can be at selective locations in the top layer 108 where traction will be needed. Thus, micro-terrain layer portions 108A, 108B can selectively provide a frictional contact surface 108D at specific places on the outer surface of the cover material 100. Micro-terrain layer portions 108A, 108B can also provide different types and intensity of micro-terrains to provide different levels of gripping surface. For example, micro-terrain layer portion 108A can have a different type and/or sized micro-terrain as compared to micro-terrain layer portion 108B. The digitally printed layer 106 can provide images useful for tactical, strategic or work-related purposes. As above in some embodiments, the different strata or layers 102, 104, 106, and 108 of the cover material 100 can include nanomaterials as described above. Alternatively, in some embodiments, nanomaterial can be excluded in layers 102, 104, 106, and 108 of the cover material 100.

Thus, as described above, the cover materials 80, 90, and 100 can be a multi-layered adhesive camouflage material featuring a micro-terrain layer 88, 99, and 108A and 1088 in the outer-most physical strata or layer for increased friction with another contacting surface for improved performance, functionality or operation. The micro-terrain layers can be selectively placed on the surface of the digitally printed layer or laminate layer and the substrate layer so that frictional contact surfaces are only in positions where they are needed. This material can have an underlying digitally printed visual camouflage design layer that is printed on the substrate layer that allows for the completion or continuation of the same visual camouflage pattern between areas of frictional need and those areas without this need. For example, the digital printed layer can be a camouflage image that provides visual cover for a physical item when the physical item is used in a situational environment where the physical item and the user should blend therein. Each substrate layer can be a polymer-based film material with or without an adhesive layer on its back-side that can be applied to a surface of a physical item. For example, if no adhesive is present of the back-side of the substrate layer, an adhesive may be applied to the physical item to which the substrate layer is to be applied. The substrate layer can be, for example, a vinyl film, such as polyvinyl chloride or polyvinyl alcohol.

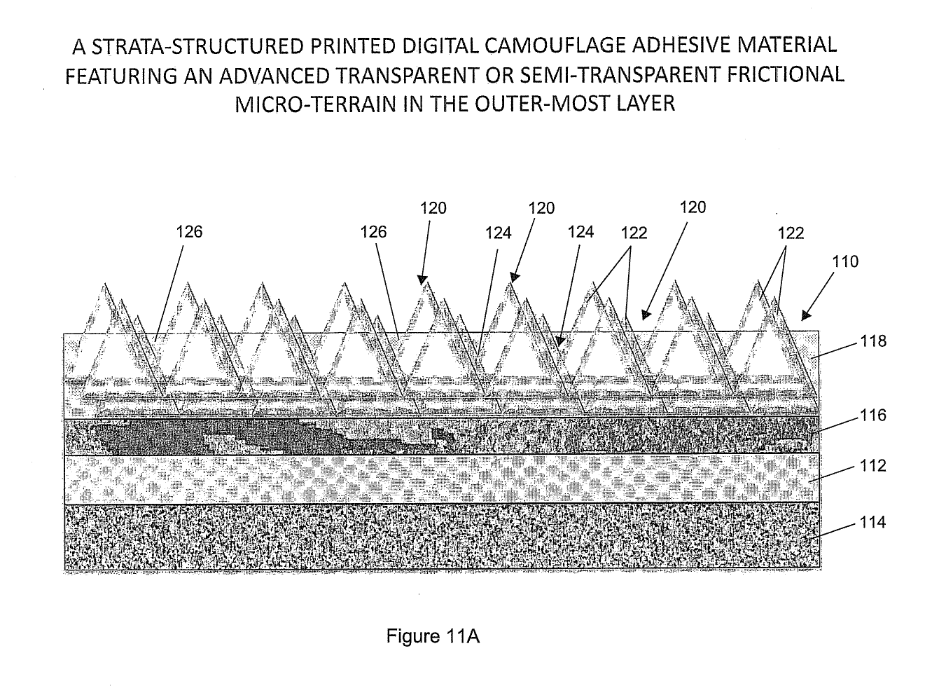

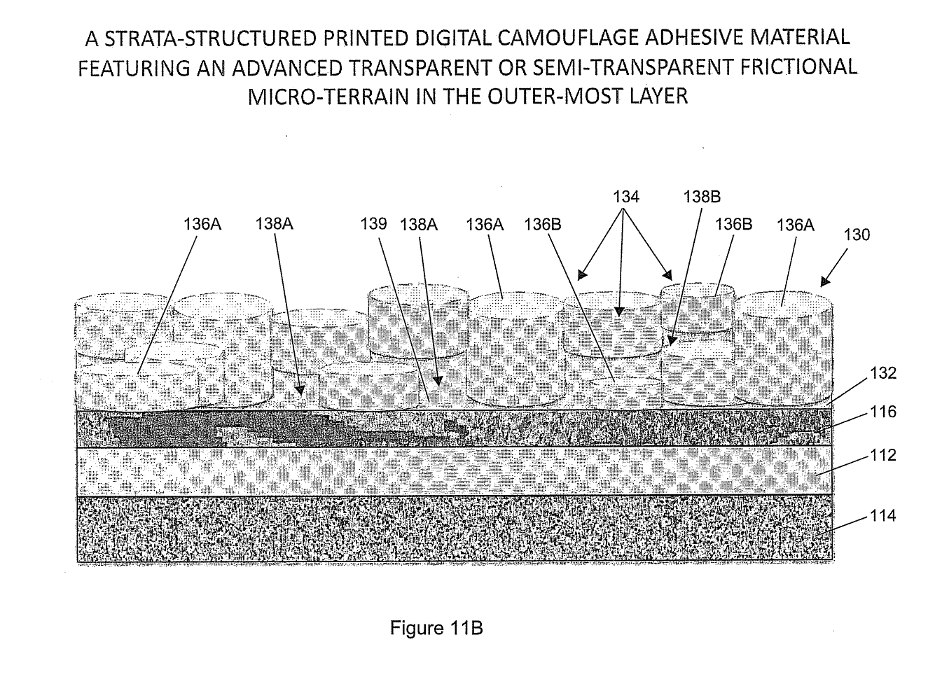

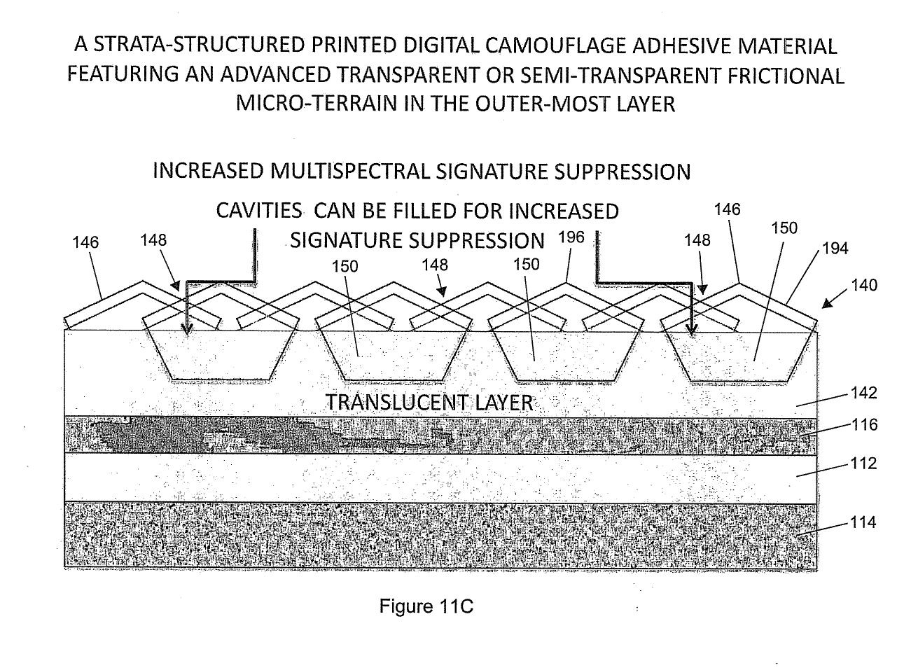

In FIG. 11A, a magnified view of a portion of a cover material generally designated 110 is provided that comprises a substrate layer 112, an adhesive layer 114 and a print layer 116. Cover material 160 also comprises a micro-terrain layer 118 with microstructures generally designated 120 on its outer surface covers and protects the substrate layer 112 and print layer 116. Microstructures 120 can include pointed ridges 122 that form peaks. The material from which micro-terrain layer 118 is constructed can be soft and pliable. Microstructures 120 also can include valleys 124 or open spaces between pointed ridges 122 or peaks. Valleys 124 can extend down to a base portion 126 of the micro-terrain layer 118.

In FIG. 11B, a different structure is provided from the microstructures. A cover material generally designated 130 is provided that comprises a substrate layer 112, an adhesive layer 114 and a print layer 116. The cover material 130 also comprises a micro-terrain layer 132 with microstructures generally designated 134. Microstructures 134 can include cylindrical ridges 136A and 136B of different sizes and heights. For example, microstructures 134 can include large cylindrical ridges 136A and small cylindrical ridges 136B. Different sized valleys 138A and 138B, or open spaces, can be formed between the large cylindrical ridges 136A and small cylindrical ridges 136B and between cylindrical ridges 136A and 136B and a base portion 139 of the micro-terrain layer 132. By increasing the differences in elevations in the physical structure of the micro-terrain layer 132, further improvements for handheld traction can be achieved. The differences in the elevational distances create the size of cavities between the “ridges and valleys” of the micro-terrain, for the accumulation of sweat and oils.

In FIG. 11C, a cover material generally designated 140 is provided that comprises a substrate layer 112, an adhesive layer 114 and a print layer 116. The cover material 140 also comprises a micro-terrain layer 142 with microstructures 144 of ridges 146 and valleys 148. The micro-terrain layer 142 can include pockets 150 with the microstructures 144. The pockets 200 beneath the microstructures 144 of the transparent or semi-transparent micro-terrain layer 142 can be filled with or can house and protect transparent or semi-transparent multi-spectral signature suppression materials therein.

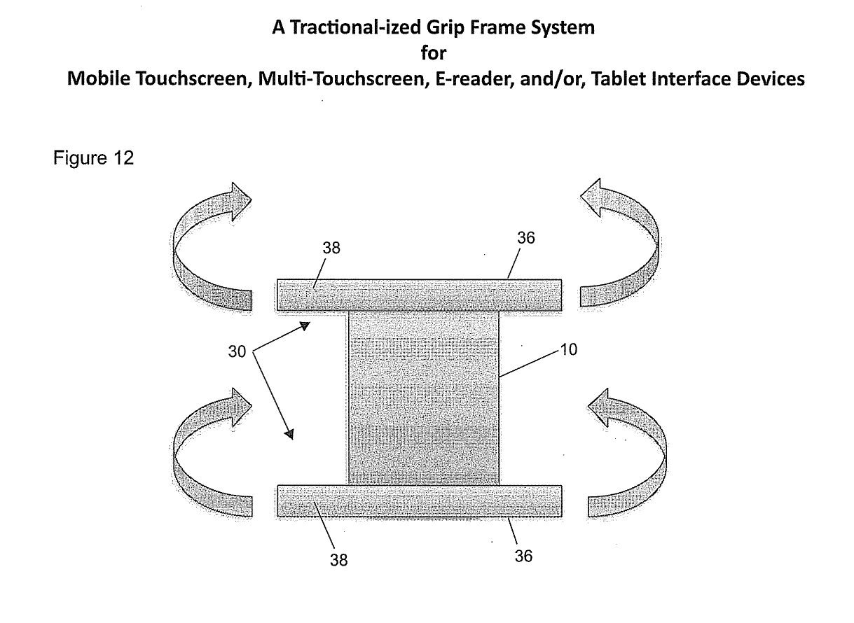

As shown in FIG. 12, the grip frame system can comprise strips 36 of traction-creating coverings 38 comprising a cover material such as cover material 40, 50. Strips 36 of traction-creating coverings 38 can be positioned around the uppermost and/or lowermost surface areas above the bezel or the gripping edge(s) of tablet device 10 that are associated with holding by the thumbs, fingers or hands of a user positioned on the front face of tablet device 10. Strips 36 of traction-creating coverings 38 can continue or extend onto one or more surfaces of tablet device 10, such as the rear face border area or gripping edge. As shown in FIG. 12, strips 36 of traction-creating coverings of grip frame system can wrap from one side of tablet device 10 and be secured and adhered to an opposite of tablet device 10.

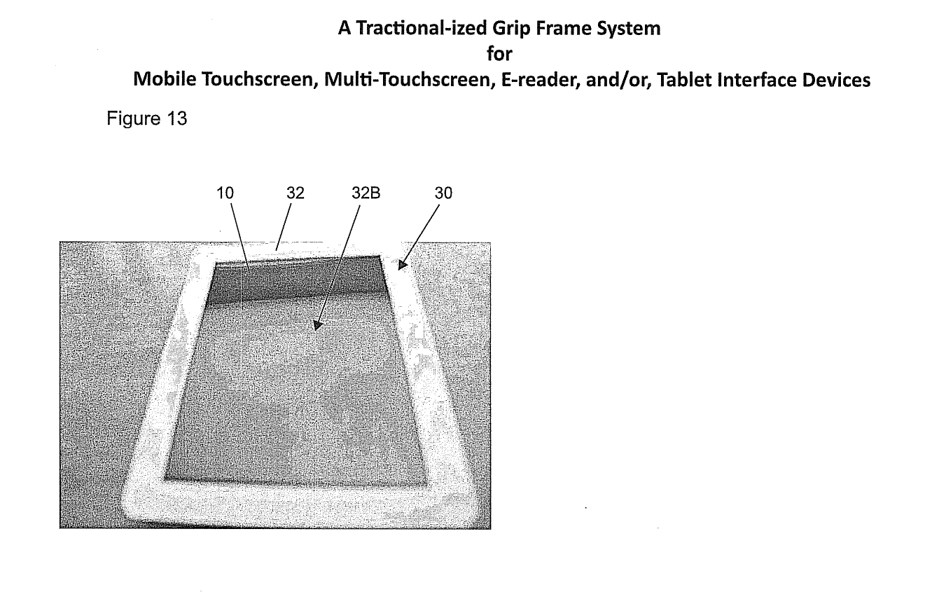

As shown in FIG. 13, the traction-creating grip frame system 30 that can comprise a traction-creating covering 32 can be a single piece that can be applied to the surface area above the bezel, or border surface on the front face or gripping edge, but leaving an inside area 32B open, exposed, or optically clear for intended capacitive touch operation and/or viewing on the tablet device 10. Alternatively, traction-creating covering 32 can comprise multiple strips or pieces.

Grip frame system 30 can comprise a cover material that can be placed over, or be incorporated into a laminate or an optically clear protective coating during a manufacturing process for the tablet device. Alternatively, grip frame system 30 can be an after market accessory that is provided for installation after the sale of the tablet device for the purpose of improved handheld traction. A micro-terrain layer 48 of a traction-creating covering 32, 34 can be a laminate or protective coating that can be transparent, semi-transparent or translucent. As stated above, micro-terrain layer 48 can, by itself serve as a traction-creating covering 32 with no image associated with it.

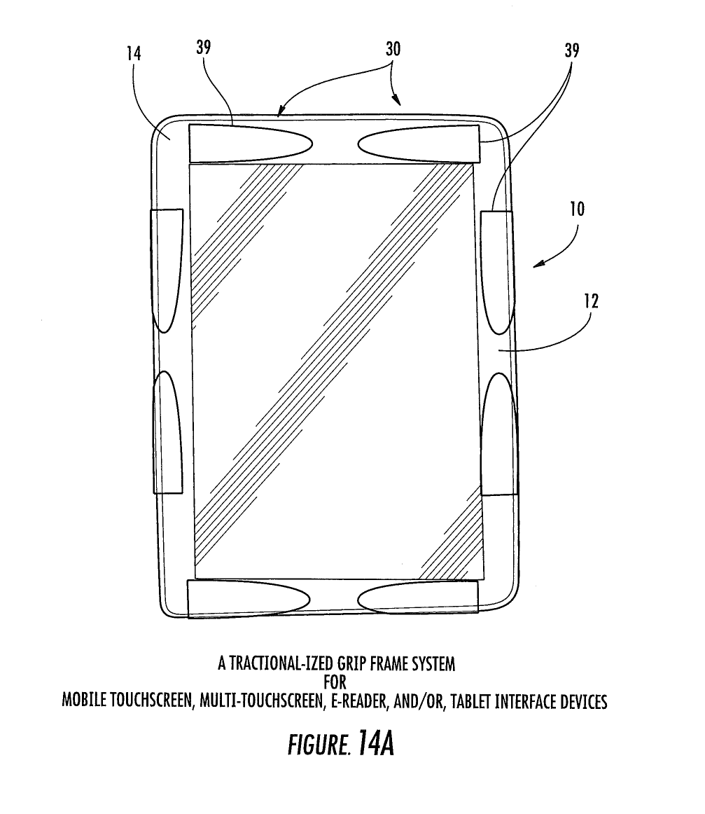

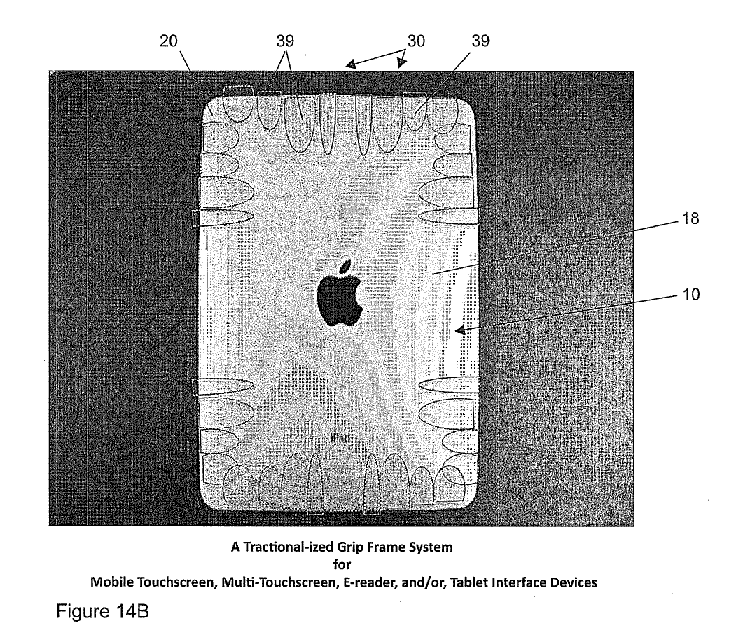

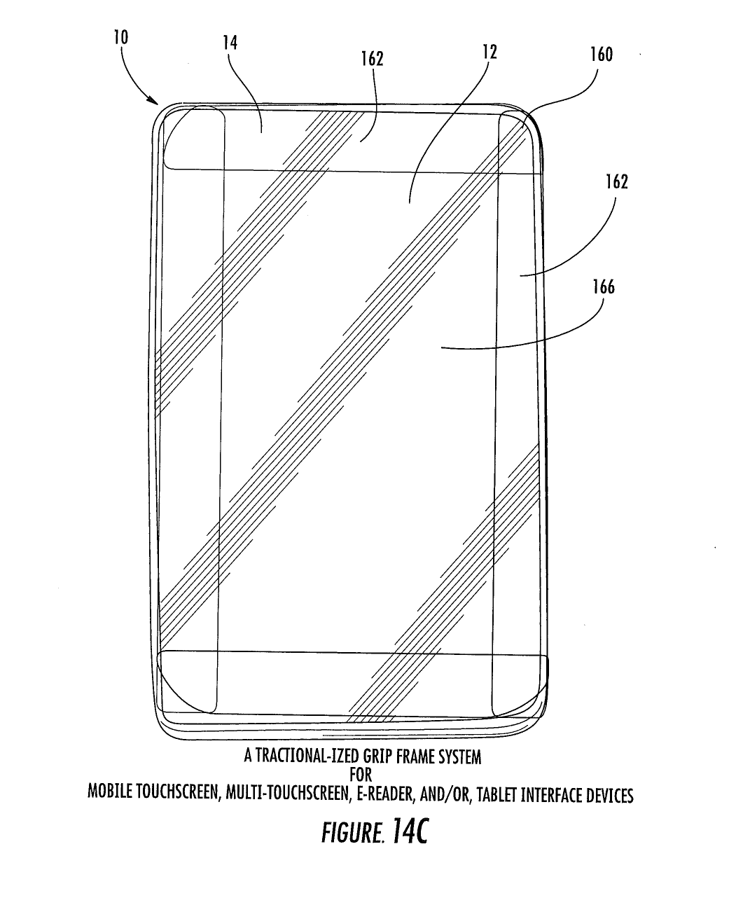

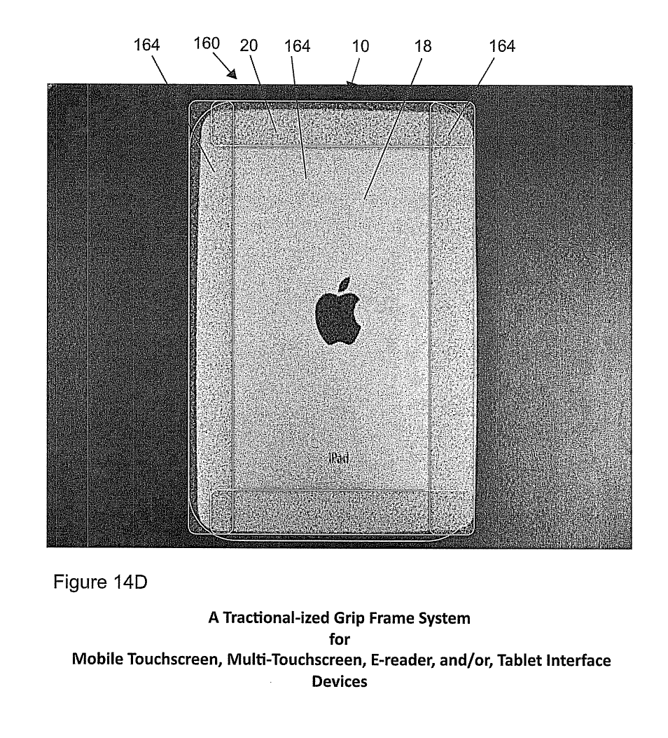

As described above, the grip frame system can comprise a cover material that can be an optically clear laminate or coating incorporated into the border areas of the tablet device that are associated with hand contact positions during operation or transport of the device. As shown in FIGS. 14A and 14B, grip frame system 30 can comprise strategically placed small strips 39 of traction-creating coverings 32, 34 on border 14 of tablet device 10 on the front face around screen 12 or on outer edge 20 of rear face 18 of tablet device 10. Here, strips 39 of traction-creating coverings 32, 34 can be just micro-terrain layer 48 with adhesive applied to back side 48A of micro-terrain layer 48. It is note that small strips 39 of traction-creating coverings 32, 34 can be any shape such as squares, rectangles, ellipses, circles, parabolic shape, irregular shapes or the like.

As shown in FIGS. 14C and 14D, grip frame system 160 can comprise traction-creating coverings 162 and 164 that have a frictional contact surface on border 14 of tablet device 10 on the front face around screen 12 or on outer edge 20 of the rear face 18 of tablet device 10. For example, micro-terrain layer 48 can be selectively positioned on design layer 46 and/or substrate layer 42 of cover material 40 at locations where frequent hand contact or gripping positions for tablet device 10 may be. Alternatively, micro-terrain layer 48 can be positioned over the entire printed design layer 46 and substrate layer 42 of cover material 40 with section of micro-terrain layer 48 being thicker or rougher sections, i.e. having more extreme microstructures, at locations where frequent hand contact or gripping positions for tablet device 10 may be.

At the same time in FIGS. 14C and 14D, screen 12 of tablet device 10 can include a cover material, such as a laminate or coating 166, that does not create a traction surface, but provides a thin protective layer that still permits visual or touch contact capabilities of screen 12. Alternatively, cover material 166 on the screen can provide a slight frictional contact surface, or micro-terrain that is more sparse in the size and distribution of the microstructures so as to provide an improved gripping surface thereon, while still not interfering with the visually or touch contact capabilities of screen 12.

In some embodiments as described above, the traction-creating coverings of the grip frame system can cover and/or conform to every outer surface of the tablet device, except the touchscreen and the respective openings for functioning of input and output (USB ports, charging ports, speaker ports, microphone ports, camera ports, or the like) portions for access by the appropriate devices.

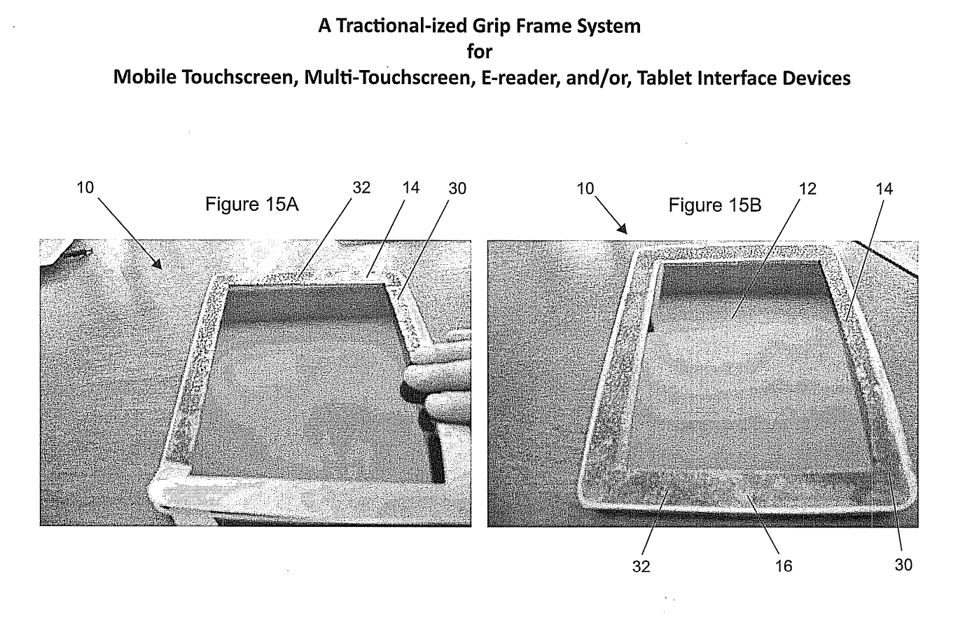

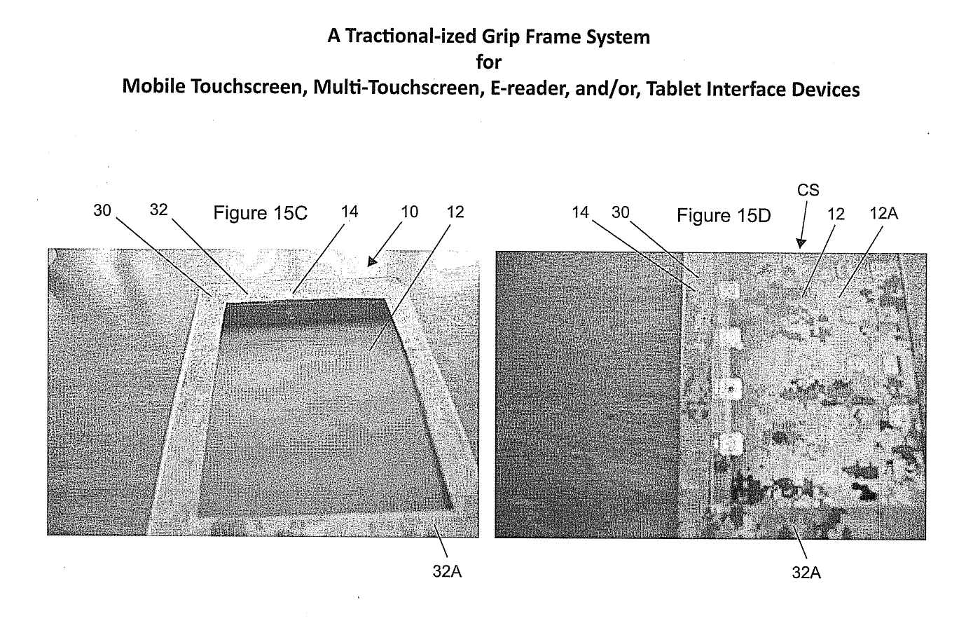

FIGS. 15A-15B illustrate that the traction-creating coverings 32 of grip frame system 30 can be placed on a border 14 around screen 12 of tablet device 10 and can cover such intelligent bezel portions as a touch-activated bezel button 16 but can still allow for the recognition of bezel-multi-touch movements of the hands of the user as intended by tablet device 10. FIGS. 15C-15D illustrate a feature that can be useful in certain applications or in certain strategic or tactical environments. FIGS. 15C-15D illustrate a tablet device generally designated 10 that has a grip frame system 30 that can comprise a traction-creating covering 32 on its frame and border 14 around screen 12. Traction-creating covering 32 can have an image 32A thereon. Screen 12 of tablet device 10 can project or display an image 12A that integrates, matches, or compliments the image on traction-creating covering 32 to create a cover system CS. As shown in FIG. 15D, covering 32 can have a camouflage image and screen 12 can project or display a camouflage image 12A that integrates, matches, or compliments camouflage image 32A on traction-creating covering 32 to create a cover system CS for a generally uniform concealment system for tablet device 10. Tablet device 10 can thereby utilize both digitally printed adhered/coated imagery and computer-electronic broadcast imagery to allow for more complete image coverage of tablet device 10.

As shown in FIGS. 15A-15D, cover material of traction-creating coverings of the grip frame system can allow the multiple touch sensitive surfaces positioned in and housed under the bezel, or intelligent bezel, to continue operation through the grip frame system while still providing handheld traction. The cover material of the traction-creating coverings of the grip frame system can enhance traction for gripping while still allowing the passage of resistive, capacitive, or surface acoustic wave signals. The cover material of the traction-creating coverings of the grip frame system can cover and conform to the outer surface of the tablet device, especially protecting the seals on the border of the tablet device from exposure.

Grip frame system 30 shown in 15C and 15D can provide coverage over the body of tablet device 10 with desired imagery and/or patterns, excluding screen 12. In these grip frame systems 30, the rear face, sides (excluding any necessary inputs and outputs, such as USB ports, charging ports, or the like) and the border surrounding the screen can be covered by cover materials such as those illustrated in FIGS. 8-11C. In such grip frame systems 30, when screen 12 of tablet device 10 projects image 12A that integrates, matches, or compliments image 32A from the digitally printed layer of the cover material as shown, for example, in FIGS. 15C and 15D, a desirable coverage system CS can be created. Thus, such a tablet device 10 utilizes both digitally printed adhered/coated imagery 32A and computer-electronic broadcast imagery 12A to allow for more complete image coverage of tablet device 10.

Such grip frame systems and coverage systems that can be utilized as a camouflage, concealment, or deception method, process and system for such touchscreen computers. For example, site-specific camouflage can be used such as the camouflage material disclosed and taught in U.S. patent application Ser. No. 12/221,540 as the cover material for such grip frame systems. For instance, the systems can utilize digitally produced, camouflage pattern imagery that can be derived through Geospatial Intelligence (hereinafter “GEOINT”), or site-specific digital photography (like PHOTO-REAL or PHOTO-STEALTH camouflage manufactured by MW Defense Systems, Inc. located in Lumberton, N.C.). The visual camouflage, concealment or deception imagery, through the use of cover material created from vinyl wrap material such as PHOTO-REAL® and PHOTO-STEALTH®, and CAMOTRACTION™ manufactured by MW Defense Systems, Inc. located in Lumberton, N.C., can be adhered to the tablet device and can completely cover the faces of the device excluding input, and output portions or those necessary for function, such as power, USB, microphone, camera, or other hardware or receptacle.

The screen of the touch-activated portion of the multi-touchscreen of a tablet device can be camouflaged by broadcasting or projecting the original digital image used to produce the printed image used to cover the exterior of the frame of the tablet device onto the viewing area. The broadcast or project image can integrate, match, or compliment the image from the cover material thereby completing a camouflage coverage on every face of the device, even while the device is in use or standby.

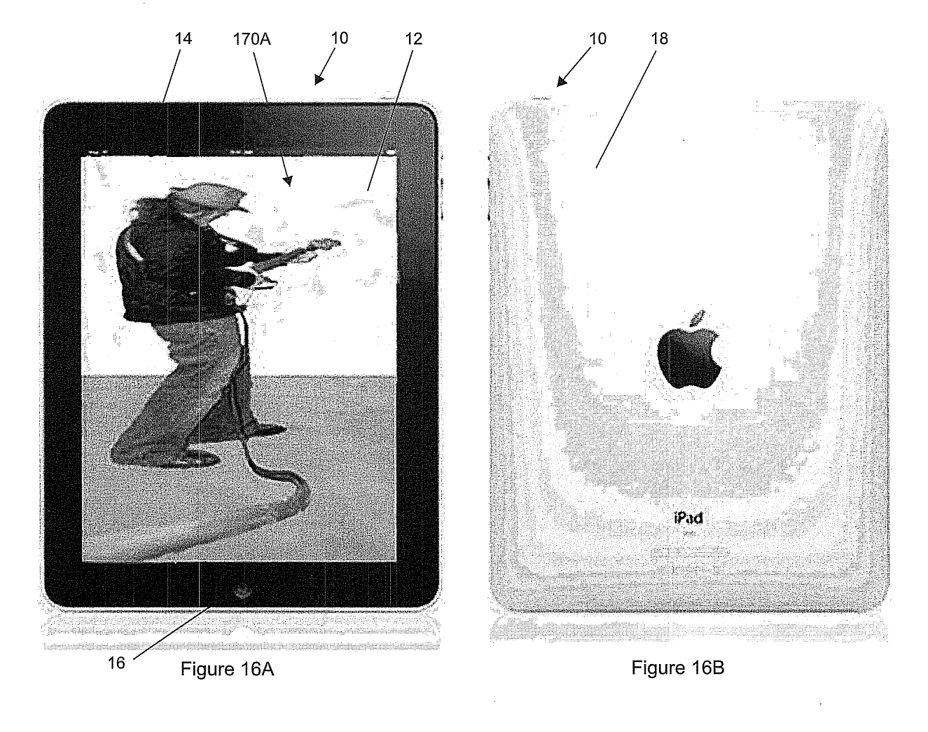

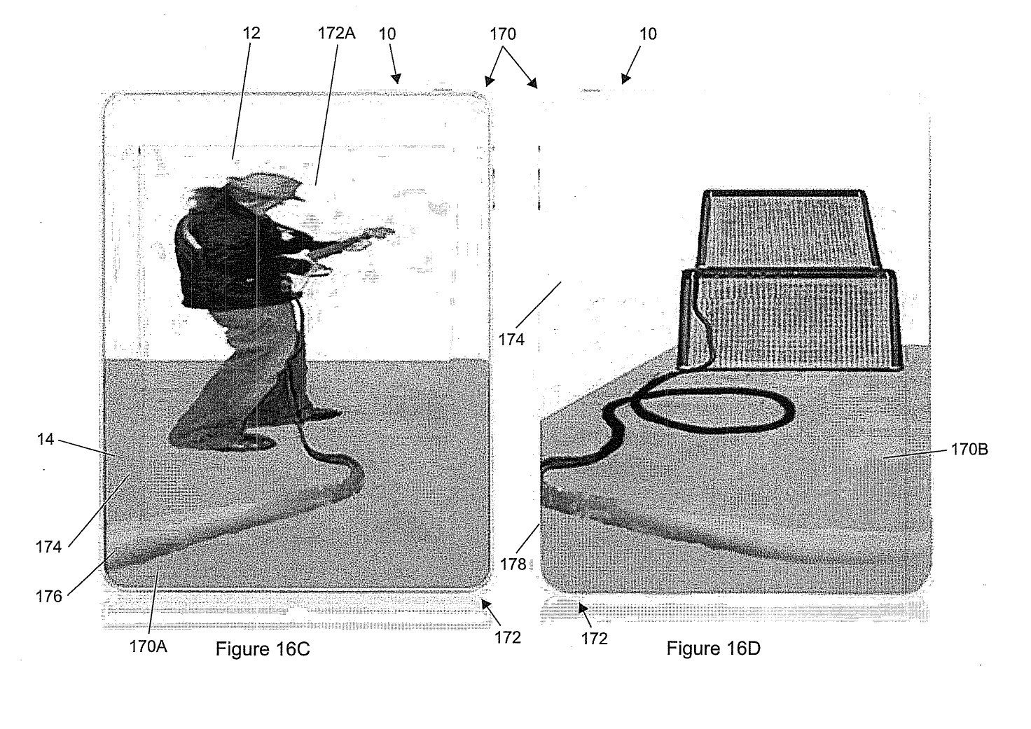

Alternatively, the grip frame system and the projected image on the screen can be a personalized image, or images, that an individual can print on the cover material of the grip frame system and project from the screen of the tablet device. The image or images can provide an integrated, complimentary, or seamless image around the tablet device. For example, FIGS. 16A-16D illustrate a commercial, or artistic example, of a grip frame system 170 that acts as a coverage system 172 for a tablet device 10 as well that integrates imagery from a cover material 174 of a grip frame system 170 and imagery that can projected on a screen 12 of a tablet device 10. FIG. 16A illustrates a front view of tablet device 10 having a border surface 14 with an intelligent bezel button 16. Tablet device 10 can also comprise touch-enabled screen 12 displaying an image 172A of a guitarist playing his guitar. Image 172A can be a screen saver image and/or a background image selected by a user of tablet device 10. FIG. 16B illustrates a back view of tablet device 10 showing a rear face 18 of device. FIGS. 16A and 16B illustrate tablet device 10 before tablet device 10 is covered by grip frame system 170 but illustrates image 172A that can be used in the illustrated cover system 172.

FIGS. 16C and 16D illustrate tablet device 10 after tablet device 10 is covered by grip frame system 170. Cover material 174 can be used to create traction covering 176 on border surfaces 14 of tablet device 10 that provides an image 170A and traction covering 178 on rear face 18 of tablet device 10 that provides an image 170B in grip frame system 170. As shown in FIGS. 16C and 16D, image 170A of traction covering 176 and image 170B of traction covering 178 can generally match in a manner that image 170A and image 170B can create a continuous image. As seen, the cord in image 170A appears to continue into image 170B. Additionally, image 170A and image 170B can generally match up with image 172A displayed on touch-enabled screen 12. In particular, image 170A of traction covering 176 used around border surface 14 of screen 12 in FIG. 16C continues image 172A displayed on screen 12 appearing to be a continuation of the cord running from the guitarist's guitar. In such a manner grip frame system 170 and image 172A can provide a cover system 172 of an aesthetic or artistic image.

Such systems illustrated in FIGS. 15A-16D allow for associated, coordinated, or complete image coverage onto the faces of a tablet device through both printed-coated/adhered means and computer-electronic means whether to provide an image for concealment or deception or to provide an image for a personal expression.

To create a design that can be a hybrid electronic-printed design image, intended to cover the exterior faces of a chosen tablet device as shown in FIG. 15A-16D. A tractional grip frame system with one or more images printed on the system's cover material can cover the non-touch enabled portions of the device, while a screen, such as a touch enabled screen, can simultaneously broadcast the corresponding, continued, or completed electronic image (which may in turn be from an alternate perspective) that matches, integrates with, or compliments the one or more images on the cover material of the grip frame system. Front and rear corresponding images can be provided and appropriately designed by the user on a template for specific type of tablet device for which the covering is intended. Once the device is chosen, the image can be converted to the format that allows for preview for further editing until the desired design is achieved. Then, the corresponding chosen printed-electronic designs can be uploaded direct to a manufacturer of the cover material for the grip frame system for production and shipping. A finished kit including both the tractional covering and the digital file for broadcast can be sent back to the user who created the design.

After the user image is selected in and/or converted to an appropriate file type, for example, JPEG files, TIFF files, PNG files, or the like, it can be converted by serializing to a Wrap App File Format designated by the suffix .WAFF. At this stage, the image can be sized to fit the intended device face by reducing or enlarging the image, or otherwise scaling it to fit the intended outer device face. After the image is scaled for the specific device, the image can be separated along template lines into the printed grip frame exterior portions and the interior remaining portions to be broadcasted from the screen. In the instance of designing for the front device face, this remaining image can be cropped and saved as a digital file for broadcast or display onto the touchscreen viewing surface, or screen, of the tablet device.

Next the image and templates can be shown visually in an overlay image on the device for preview. The manufacturer can send the images for preview to the user. If the images previewed are not acceptable, then the templates can be enabled for editing to correctly place the images within the template by moving the images, or enlarging, reducing or cropping them. If the images previewed are acceptable, then the templates can be can be sent to the manufacturer or uploaded to the manufacturer's website for production. Both the printed imagery and the digital file that comprise the associated front face broadcast image can then sent to the user for use and application.

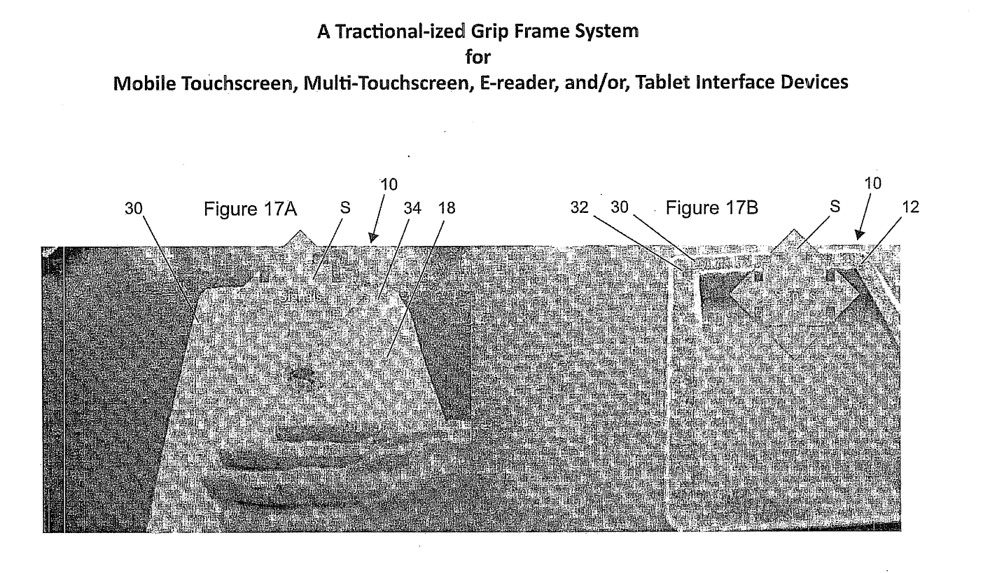

As shown in FIGS. 17A-17B, traction-creating coverings 32, 34 on the respective borders 14 around screen 12 and rear face 18 of tablet device 10 and/or other cover material (see, for example, covering 166 on screen 12 in FIG. 14C) of grip frame system 30 can allow broadcast and reception of signals S, or frequencies, required by tablet device 10 for operation. This signal transparency can be accomplished, for example, by the type and thickness of traction-creating coverings and/or other cover material used and the materials used therein.

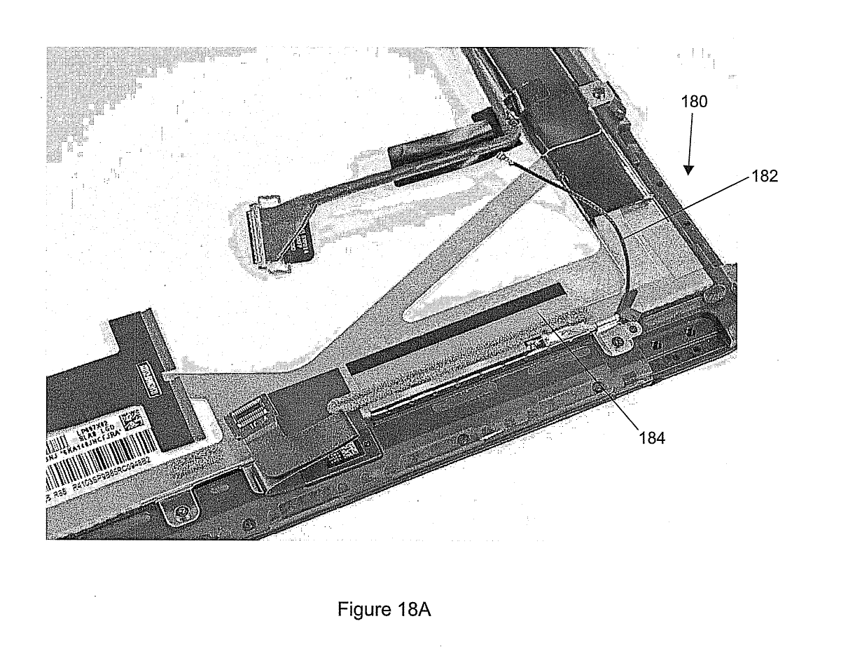

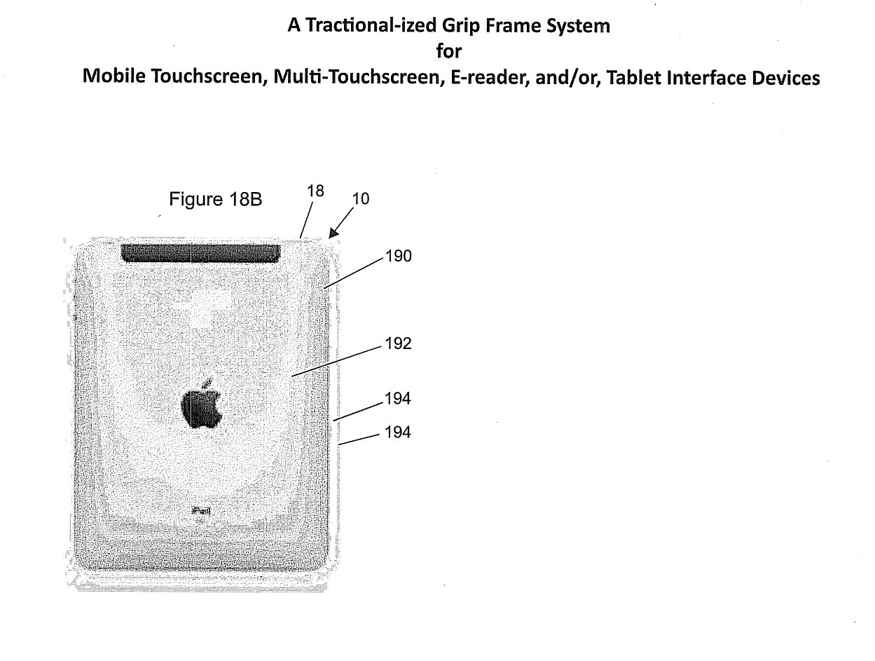

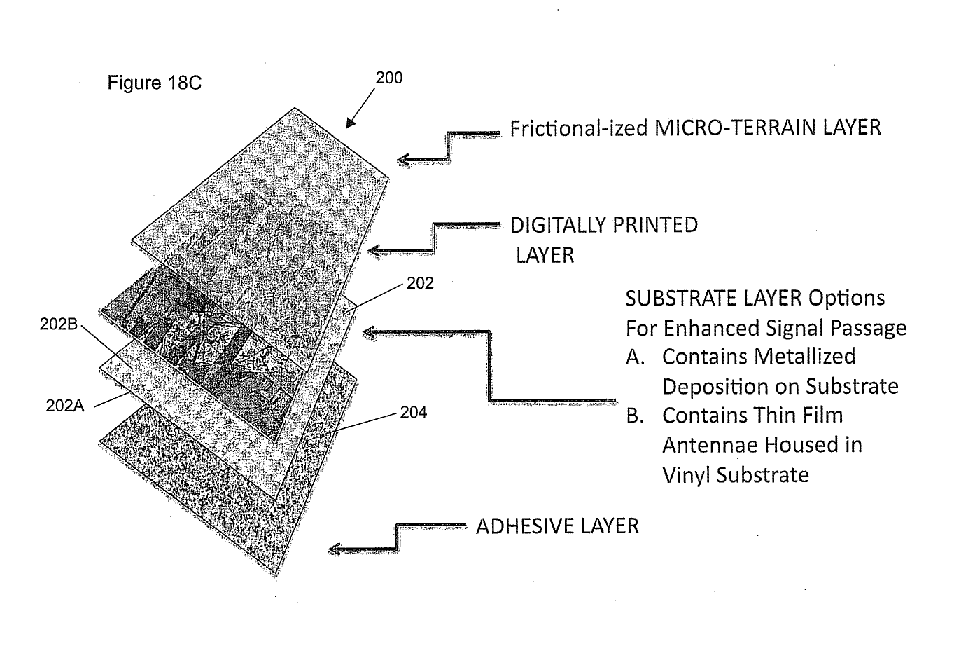

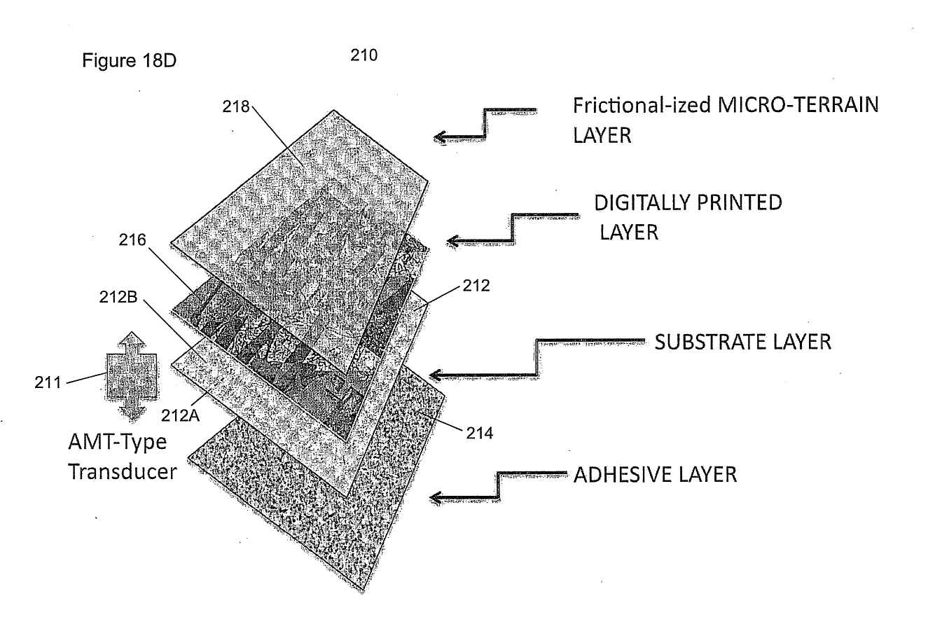

Alternatively, an antenna used on the tablet device can be enhanced, modified, or supplemented. FIGS. 18A-18D illustrate antenna-related aspects of grip frame systems and the tablet devices on which they can be used. FIG. 18A shows an antenna system that can be employed in a tablet device. In particular, FIG. 18A shows a portion of a frame 180 of a tablet device that includes a first antenna 182 and can optionally include a second antenna 184 that can provide enhanced signal reception for receiving and transmitting information from the tablet device. In such embodiments of a tablet device, the thickness of the traction-creating coverings of the grip frame system (for example a strata structure as described above) can be sufficiently thin enough to allow signal passage. In some embodiments, the cover material of the grip frame system can include perforations to permit such signal passage.

For example, FIG. 18B illustrates a rear face 18 of tablet device 10 can have a traction covering 192 of cover material 190 that can have perforations 194. Perforations 194 can be a size that limits them from being visually perceived by an observer. Perforations 194 can vary in size or be a consistent size within the same traction covering 192. Additionally, depending on the strength of the antenna within tablet device 10, the sizes of perforations 194 within different cover materials 190 can vary.

In some embodiments, an antenna array that can be housed or embedded in a cover material can be used in a grip frame system and attached to a tablet device for enhanced signal capabilities. For example, FIG. 18C illustrates a cover material 200 similar to some of those described above that can comprise a substrate layer 202 with an adhesive layer 204 on its back side 202A, a printed layer 206 on a front side 202B of substrate layer 202 and a micro-terrain layer 208. In substrate layer 202, a metal deposition can be disposed onto/into substrate 202 to form a strata-structure that enhances signal capabilities by allowing the penetration of the signal through the strata structured, metalized cover material. The thin substrate layer 202, positioned under micro-terrain layer 208, and above adhesive layer 204, can be produced by broadcasting the metal antenna material and embedding it into the substrate layer 202 by sputter deposition also creating a larger surface area for the antenna. Alternatively, a separate thin film multi-band antenna or array can be sufficiently thin enough to be embedded or housed into substrate layer 202 under micro-terrain layer 208 and printed layer 206, but above adhesive layer 204. An example of thin film multi-band antennae is provided in U.S. Patent Publication No. 2010/0026590 of U.S. patent application Ser. No. 12/102,160, from which the description of the antennae is incorporated herein by reference.

In some embodiments as shown in FIG. 18D, a cover material 210 can be provided that includes an advanced membrane transducer 211(“AMT transducers”) type antenna or array. Cover material 210, as above, can comprise a substrate layer 212 with an adhesive layer 214 on its back side 212A, a printed layer 216 on a front side 212B of substrate layer 212 and a micro-terrain layer 218. Such an advanced membrane 211 can be embedded in cover material 210 in position between adhesive layer 204 and micro-terrain layer 218. AMT Transducer 211 can be placed in micro-terrain layer 218 or substrate layer 212. Other examples of placement of AMT transducer 211 can include placement in micro-terrain layer 218, between micro-terrain layer 218 and substrate layer 212, or beneath layer 212.

The placement of an AMT transducer in a grip frame system or the underlying device can possess more than a singular benefit. Along with enhanced signal receiving and transmitting capabilities, AMT transducers that are embedded into a cover material for a grip frame system for a tablet device can yield other separate, but desirable attributes. These attributes can include solar capabilities, audio capabilities, and multi-band signal capabilities with lightweight coverage, grip and ability to retrofit.

Additionally, the cover material of traction-creating coverings of a grip frame system as described above can be applied to a light weight or rugged case, specific for a tablet device, which does not already feature a tractional or frictional surface. The traction-creating coverings of the grip frame system can be adhered to or coat the surface of the case for increased handheld traction during operation or transport. These traction-creating coverings, as described above, can comprise a strata-structured micro-terrain.

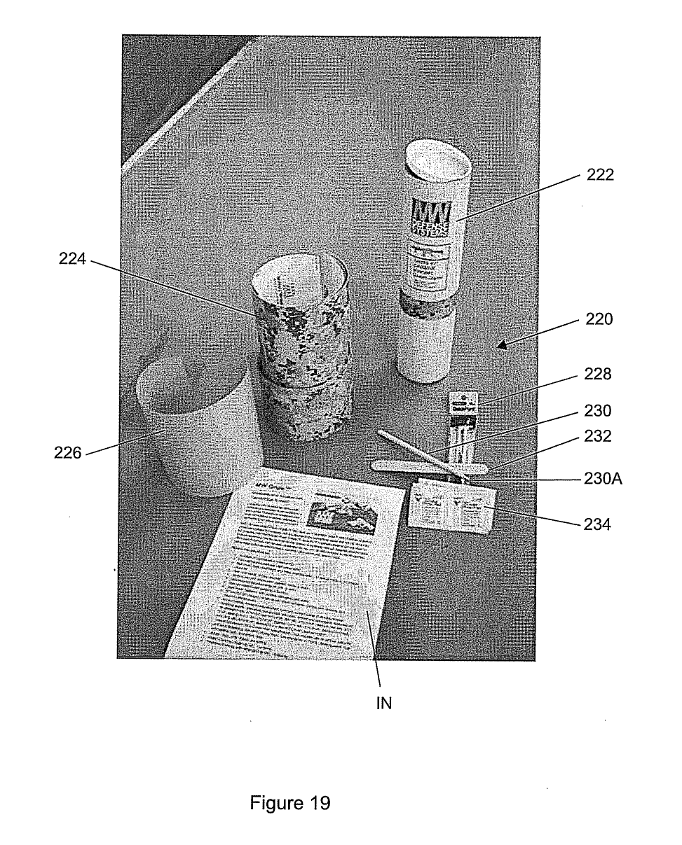

The traction-creating coverings of the cover material for the grip frame system disclosed herein can be provided in a kit, which is an embodiment already pre-cut, designed and sized for an intended device type. For example FIG. 19 illustrates a kit, generally designated 220, that includes material and components used to effectively camouflage weapons and other accessories. Each kit 220 can include material and components that are specific to a specific weapon-type or specific accessory. Alternatively, kit 220 can be a generic kit that includes components that can cut and fit the materials to generally any hand weapon or accessory.

Kit 220 can comprise a container 222 can be used to ship and store the kit materials and components. The kit can comprise cover material panels 224 that may or may not comprise a micro-terrain layer. These panels 224 can be specifically shaped to a specific tablet device or can be general sizes that permit the panels to be cut to fit a specific tablet size during application. Cover material panels 224 can comprise a printed layer that provides an image over at least a portion of one of cover material panels 224.

Kit 220 can also optionally comprise extra transparent or semi-transparent cover material panels 226 that comprise a micro-terrain layer as described above. These extra transparent or semi-transparent cover material panels 226 that comprise a micro-terrain layer can be specifically shaped to a specific tablet device for a specific grip frame set-up or can be general sizes that permit the panels 226 to be cut to customize a grip-frame system set-up during application. The micro-terrain layer panels 226 can be clear or translucent enough to limit its interference with any image on layer panels 224 over which the panels 226 are applied. As shown, the micro-terrain layer panels 226 have a backing that can be removed for application.

Kit 220 can also include different components used in installing panels 224 and 226. For example, kit 220 can include a knife 228 for cutting the respective panels 224 and 226 as needed to fit a tablet device. For instance, the knife 228 can be a clip blade knife. Kit 220 can include a detail stick 220 that can be used to apply the respective panels 224 and 226 to a tablet device. Detail stick 230 can have a point 230A that can be used to ensure even and tight application in crevices in corners in the tablet device. Kit 220 can also include a flat detail stick 232 that can be used to apply the respective panels 224 and 226 to a tablet device. Flat detail stick 232 can be used to apply the respective panels 224 and 226 on larger, generally more flat surfaces of a tablet device to remove bubbles under the panels and ensure an even tight application of the respective panels 224 and 226. Kit 220 can also include cleaning components, such as alcohol prep wipes 234. Alcohol prep wipes 234 can be used to clean the tablet device before application of the respective panels 224 and 226 thereto. The cleaning components can be something other than alcohol prep wipes, for example, a container of a cleaning agent and a cloth or cotton swaps. Kit 220 can also include instructions IN on how to use kit 220 to apply a grip frame system to a tablet device. The instructions can be tablet device specific or can be more generic.

Embodiments of the present disclosure shown in the drawings and described above are exemplary of numerous embodiments that can be made within the scope of the present subject matter. It is contemplated that the configurations of systems for tractional grip frames for tablet devices and related methods can comprise numerous configurations other than those specifically disclosed.

1. A grip frame system for creating gripping surfaces on a tablet device, the grip frame system comprising:
one or more traction-creating coverings positionable on a portion of at least one of a border surrounding a screen of the tablet device, sides of the tablet device, or a rear face of the tablet device; and
the traction-creating coverings comprising one or more micro-terrain layers forming an outer surface at selected locations to form a frictional contact surface.

2. The grip frame system according to claim 1, wherein the one or more traction-creating coverings are transparent, semi-transparent, or translucent.

3. The grip frame system according to claim 1, wherein the one or more micro-terrain layers are transparent, semi-transparent, or translucent.

4. The grip frame system according to claim 3, wherein the one or more traction-creating coverings further comprise a substrate layer on which the one or more micro-terrain layers are attached, the substrate layer having an image printed thereon with the image being viewable through the one or more micro-terrain layers.

5. The grip frame system according to claim 4, wherein the image is a camouflage image.

6. The grip frame system according to claim 4, wherein the screen on the tablet device is adapted for displaying an image that integrates, matches, or compliments the image on the substrate layer.

7. The grip frame system according to claim 4, wherein one or more traction-creating coverings are positioned on the border surrounding the screen of the tablet device.

8. The grip frame system according to claim 7, wherein one or more traction-creating coverings are positioned on the rear face of the tablet device.

9. The grip frame system according to claim 8, wherein the image on the substrate of the traction-creating covering on the rear face integrates, matches, and/or compliments the image on the substrate of the traction-creating covering on the border surrounding the screen of the tablet device.

10. The grip frame system according to claim 7, wherein a bezel or other touch-initiated element is engagable through the one or more traction-creating covering.

11. The grip frame system according to claim 1, further comprising a cover material positionable over the screen of the tablet device.

12. The grip frame system according to claim 11, wherein the cover material positionable over the screen of the tablet device permits touch-initiated elements of the screen to be engaged through the one or more traction-creating covering.

13. The grip frame system according to claim 1, further comprising an antenna for enhanced signal receiving and transmitting capabilities for the tablet device.

14. The grip frame system according to claim 13, wherein the antenna is a thin film antenna that is disposed in the one or more traction-creating coverings.

15. The grip frame system according to claim 1, wherein the one or more micro-terrain layers further comprise microstructures that create ridges and valleys on the outer surface.

16. The grip frame system according to claim 1, wherein the one or more micro-terrain layers further comprises a back face and a reverse printed image on the back face.

17. The grip frame system according to claim 1, wherein the one or more traction-creating coverings further comprises a cover material, the cover material comprising:
a substrate layer configured to conform and be positioned on at least a portion of the tablet device, the substrate layer having a front side and a back side,
an adhesive layer disposed on a back side of the substrate, the adhesive layer comprising an adhesive that is securable to the tablet device to hold the traction-creating coverings on the tablet device; and
the one or more micro-terrain layers with the one or more micro-terrain layers disposed on at least a portion of the front side of the substrate layer.

18. The grip frame system according to claim 17, wherein the cover material further comprises a printed layer disposed on the front side of the substrate layer with the one or more micro-terrain layers disposed on top of at least a portion the printed layer.

19. The grip frame system according to claim 18, wherein the one or more micro-terrain layers are transparent, semi-transparent, or translucent.

20. The grip frame system according to claim 17, wherein the printed layer provides an image.

21. A grip frame system for creating gripping surfaces on a tablet device, the grip frame system comprising:
one or more traction-creating coverings positionable on a portion of at least one of a border surrounding a screen of the tablet device, sides of the tablet device, or a rear face of the tablet device, the traction-creating coverings comprising a cover material, the cover material comprising:
a substrate layer configured to conform and be positioned on at least a portion of the tablet device, the substrate layer having a front side and a back side,
an adhesive layer disposed on a back side of the substrate, the adhesive layer comprising an adhesive that is securable to the tablet device to hold the traction-creating coverings on the tablet device;
a printed layer disposed on the front side of the substrate layer, the printed layer providing an image; and
one or more transparent micro-terrain layers with the one or more micro-terrain layers disposed over at least a portion of the printed layer on the front side of the substrate layer with the image being viewable through the one or more micro-terrain layers, the one or more micro-terrain layers forming an outer surface at selected locations that forms a frictional contact surface.

22. The grip frame system according to claim 21, further comprising an antenna for enhanced signal receiving and transmitting capabilities for the tablet device disposed within the cover material.

23. The grip frame system according to claim 21, further comprising nanoparticles disposed within the cover material.

24. The grip frame system according to claim 23, wherein the nanoparticles comprise an antenna for enhanced signal receiving and transmitting capabilities for the tablet device disposed within the cover material.

25. The grip frame system according to claim 23, wherein the nanoparticles comprise at least one thermal suppression particles or radar suppression particles.

26. The grip frame system according to claim 21, wherein the cover material comprises a substrate layer that is positionable over the screen of the tablet device that permits touch-initiated elements of the screen to be engaged through the one or more traction-creating covering.

27. The grip frame system according to claim 21, wherein the one or more micro-terrain layers further comprise microstructures that create ridges and valleys on the outer surface.

28. A method for applying a grip frame system to a tablet device for creating gripping surfaces on the tablet device, the method comprising:
providing a tablet device;
providing one or more traction-creating coverings comprising one or more micro-terrain layers forming an outer surface at selected locations to form a frictional contact surface; and
securing the one or more traction-creating coverings on a portion of at least one of a border surrounding a screen of the tablet device, sides of the tablet device, or a rear face of the tablet device.

29. The method according to claim 28, wherein the step of securing comprises attaching the one or more micro-terrain layers to the tablet device with an adhesive layer.

30. The method according to claim 29, wherein the adhesive layer comprises microballoons of adhesive.

31. The method according to claim 30, wherein the step of securing further comprises breaking the microballoons of adhesive layer to release the adhesive to hold the one or more micro-terrain layers to the tablet device.

32. The method according to claim 29, wherein the adhesive layer is disposed on the one or more micro-terrain layers on a side of the adhesive layer and a metallic poly-coated backing is disposed on an opposite side of the adhesive layer.

33. The method according to claim 32, wherein the step of securing further comprises heating the metallic poly-coated backing to activate the adhesive layer.

34. The method according to claim 33, wherein the step of securing further comprises removing the metallic poly-coated backing from the adhesive layer and attaching the one or more micro-terrain layers to the tablet device with the adhesive layer.
